(19) United States
(12) Patent Application Publication
(10) Pub. No.: US 2015/0317676 A1
(43) Pub. Date: Nov. 5, 2015

(54) SYSTEMS AND METHODS FOR MONITORING AND RESPONDING TO CUSTOMER FEEDBACK

(71) Applicant: Vibe-It LLC, Manhattan, KS (US)

(72) Inventors: Joshua L. Reid, Manhattan, KS (US); Jeffrey D. Smith, Manhattan, KS (US)

(21) Appl. No.: 14/702,161

(22) Filed: May 1, 2015

Related U.S. Application Data
(60) Provisional application No. 61/987,120, filed on May 1, 2014.

(51) Int. Cl. G06Q 30/02; G06Q 50/00

(52) U.S. Cl. CPC G06Q 30/0255; G06Q 50/01; G06Q 30/0267

(57) ABSTRACT

Systems and methods for sending promotions to customers. One system includes a server configured to provide a user interface accessible by an organization over a network connection. The server receives promotion data from the organization through the user interface for a promotion. The promotion data includes at least one offer, an expiration date, and criteria for publishing the promotion. The server collects customer feedback associated with the organization from a plurality of channels. The customer feedback includes feedback from a customer. The server compares the feedback from the customer to the criteria for publishing the promotion. When the feedback satisfies the criteria for publishing the promotion, the server sends the promotion to the customer.

### RELATED APPLICATIONS

This application claims priority to U.S. Provisional Application No. 61/987,120 filed May 1, 2014, the entire content of which is hereby incorporated by reference.

### FIELD

Embodiments of the present invention relate to systems and methods for monitoring feedback, such as customer feedback, and, in some embodiments, responding to the feedback.

### BACKGROUND

Organizations (e.g., businesses, individuals, educational institutions, sports programs, etc.) often provide multiple channels for customers (including potential customers) to view information regarding the organization. For example, an organization can provide a publicly-available website, a publicly-available social media website, a software application (e.g., for a mobile device, such as a smart phone, smart watch, tablet computer, personal computer, etc.), or combinations thereof. Through one or more these channels, customers may also be allowed to provide feedback regarding the organization (e.g., quality of service, quality of products, quality of channels, atmosphere, etc.).

### SUMMARY

Organizations can benefit from customer feedback. In particular, customer feedback can identify areas of improvement for the organization that the organization may not be aware of. Accordingly, organizations can benefit from eliciting targeted feedback. Similarly, organizations can benefit from responding to customer feedback on an organizational level (e.g., changing policies) and on a customer level (providing reassurance and gratitude to customers providing feedback).

As technology advances, customers have numerous ways to provide customer feedback to an organization. For example, an organization often has a website and one or more social media websites where customers can interact with the organization. Also, some organizations provide software applications (“mobile applications”) that also interface with customers. Similarly, third-parties also offer websites, social media websites, and software application that allow customers to provide feedback for various organizations (e.g., mobile applications that allow customers to review and rate a directory of organizations). Accordingly, soliciting and managing feedback from all of these access points can be difficult and time-consuming for an organization. Furthermore, organizations typically want to maintain a personal connection with customer even in the face of this technology. Therefore, the creation and wide-use of the Internet has established technical problems for organizations to properly handle customer feedback.

Therefore, embodiments of the invention provide systems and methods for collecting, monitoring, and responding to feedback (e.g., by providing responses or promotions in response to feedback). For example, some embodiments of the invention provide a customer experience center (“CEC”) software application (referred to herein as the CEC). The CEC can provide a website accessible to an organization through a browser application over a network connection, such as the Internet. The CEC can generate a user interface that allows the organization to manage surveys and other feedback mechanisms. In particular, through the CEC an organization can create new surveys and push the surveys (e.g., automatically or manually through links) to one or more channels (e.g., a website, a social media website, an application, etc.). The CEC collects customer feedback from the channels and displays the collected feedback to the organization, which also allows the organization to monitor feedback (e.g., see survey results, see ratings, etc.) and respond to feedback. Responses to feedback can be provided privately (i.e., to the customer who initially provided the feedback) or publicly. In some embodiments, the response to feedback includes a promotion or a reward (e.g., coupon). The promotion can be customized or tailored for a particular customer. For example, the promotion can be tailored based on the customer's demographics (e.g., age, gender, etc.) and/or current or past locations (e.g., state, region, city, buildings, etc.). In some embodiments, the promotion can also be tailored based on the customer's prior feedback (e.g., submitted survey answers).

For example, one embodiment of the invention provides a computer-implemented method for sending a promotion to a customer. The method includes providing, with a server, a user interface accessible by an organization over a network connection and receiving, through the user interface, promotion data from the organization for the promotion, the promotion data including at least one offer, an expiration date, and criteria for publishing the promotion. The method also includes collecting, with the server, customer feedback associated with the organization from a plurality of channels, the customer feedback including feedback from the customer, comparing, with the server, the feedback from the customer to the criteria for publishing the promotion, and when the feedback satisfies the criteria for sending, with the server, the promotion to the customer.

Another embodiment of the invention provides a system for sending a promotion to a customer. The system includes a server configured to provide a user interface accessible by an organization over a network connection. The server receives promotion data from the organization through the user interface for a promotion. The promotion data includes at least one offer, an expiration date, and criteria for publishing the promotion. The server collects customer feedback associated with the organization from a plurality of channels. The customer feedback includes feedback from a customer. The server compares the feedback from the customer to the criteria for publishing the promotion. When the feedback satisfies the criteria for publishing the promotion, the server sends the promotion to the customer.

Other aspects of the invention will become apparent by consideration of the detailed description and accompanying drawings.

### BRIEF DESCRIPTION OF THE DRAWINGS

FIG. 1 schematically illustrates a system for collecting, monitoring, and responding to customer feedback.

FIGS. 2-28 illustrate user interfaces generated by a customer experience center software application included in the system of FIG. 1.

FIG. 30 illustrates a method of creating and publishing a survey using the system of FIG. 1.

FIGS. 31 and 32 illustrate methods for generating personalized promotions using the system of FIG. 1.

FIGS. 32-48 illustrate user interfaces generated by a mobile application communicating with the customer experience center software application included in the system of FIG. 1.

FIG. 49 is a flow chart illustrating a method for sending a promotion to a customer.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be utilized to implement the invention. It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “computer” and “computing device” described in the specification can include one or more processors, one or more memory modules including non-transitory computer-readable medium, one or more input/output interfaces, and various connections (e.g., a system bus) connecting the components.

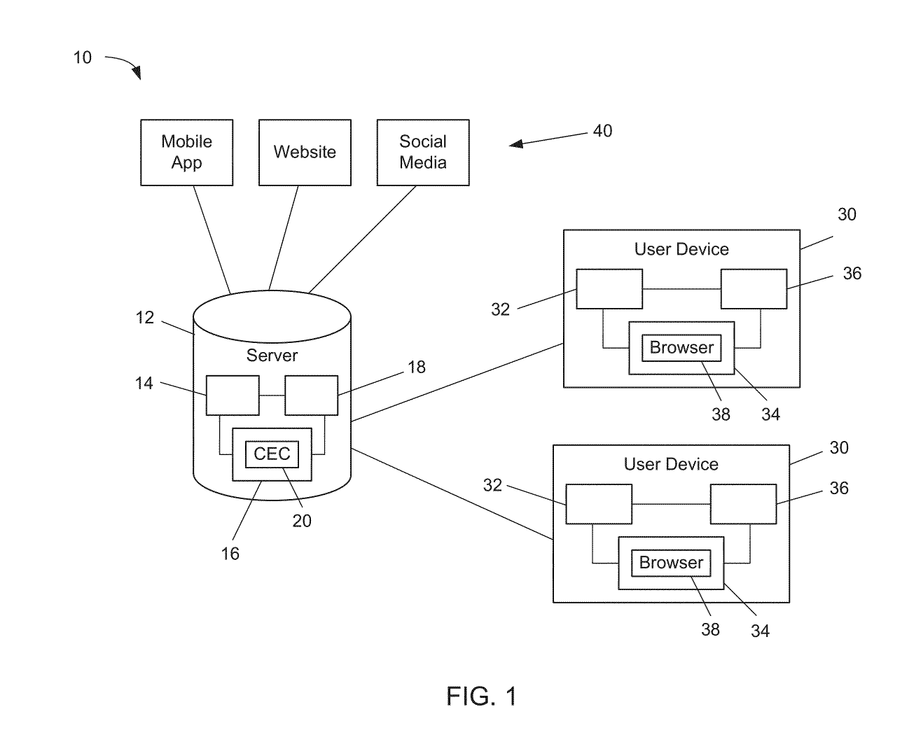

FIG. 1 illustrates a system 10 for collecting, monitoring, and responding to customer feedback. The system 10 includes a server 12. The server 12 can include one or more processing units 14, one or more computer-readable memory modules 16 (e.g., including non-transitory memory, such as random access memory and/or read-only memory), and one or more communication interfaces 18. It should be understood that in some embodiments, the server 12 includes additional components. It should also be understood that, in some embodiments, the functionality provided by the server 12 as described below can be distributed among multiple servers.

The communication interfaces 18 allow the server 12 to communicate with external devices over one or more wired or wireless networks (e.g., the Internet, a local area network, etc.). For example, as illustrated in FIG. 1, the server 12 can communicate with a plurality of user devices 30 and a plurality of channels 40. The processing units 14 can include a microprocessor configured to execute instructions stored in the memory modules 16. The memory modules 16 can also store data used with and generated by execution of the instructions. For example, as illustrated in FIG. 1, the memory modules 16 included in the server 12 store a customer experience center (“CEC”) software application (referred to herein as the CEC 20). As described in more detail below, the CEC can be configured to collect customer feedback for an organization and allow the organization to generate feedback collection mechanisms (e.g., surveys), view collected feedback, monitor collected feedback, and respond to collected feedback. As used in the present application, the term “customer” includes an individual that views, uses, or buys (including leasing, licensing, etc.) a product, service, or information (even if the product, service, or information is free) and an individual who is potentially going to view or buy a product, service, or information (even if the product, service, or information is free). As used herein, the term “customer” can also include employees, contractors, and partners associated with a particular organization. Similarly, as used in the present application, the term “organization” includes a company, an individual, or any other grouping of individuals. Also, the term “feedback,” as used in the present application, can include direct customer feedback (e.g., survey responses, complaints, praises, compliments, comments, trivia answers, etc.) and indirect customer feedback (e.g., traffic and usage information, including campaign viewings, promotion redemptions, rewards collected, reward points accumulated, etc.).

As noted above, the server 12 communicates with a plurality of user devices 30. The user devices 30 can include personal computing devices, such as desktop computers, laptop computers, tablet computers, smart phones, smart watches, smart televisions, etc. As illustrated in FIG. 1, each user device 30 can include one or more processing units 32, one or more computer-readable memory modules 34 (e.g., including non-transitory memory, such as random access memory and/or read-only memory), and one or more communication interfaces 36. It should be understood that in some embodiments, the user devices 30 includes additional components.

The processing units 32 can include a microprocessor configured to execute instructions stored in the memory modules 34. The memory modules 34 can also store data used with and generated by execution of the instructions. The communication interfaces 36 allow the user devices 30 to communicate with external devices over one or more wired or wireless networks (e.g., the Internet, a local area network, etc.). For example, as illustrated in FIG. 1, the user devices 30 communicate with the server 12. In particular, in some embodiments, the memory modules 34 included in the user devices 30 can store a browser application 38 that allows the user devices 30 to access a website provided by the CEC 20 executed by the server 12 (e.g., over the Internet). In other embodiments, the user devices 30 store a special-purpose application that allows the devices 30 to access functionality provided by the CEC 20. Also, it should be understood that, in some embodiments, all or a portion of the functionality provided by the CEC 20 can be provided by a software application stored on the user devices 30. For example, in some embodiments, the CEC 20 is stored and executed on a user device 30.

As noted above, the server 12 also communicates with a plurality of channels 40. As used in the present application, the term “channel” includes access points between a customer and an organization. For example, the channels 40 can include a website provided by the organization or a third-party (e.g., a business directory website), a social media website associated with the organization, or a software application provided by the organization or a third-party (e.g., a mobile application provided by the organization or a third-party, such as an application provided by a third-party that allows a customer to review various organizations). Accordingly, the CEC 20 accesses and collects customer feedback provided through various channels 40 to provide an organization a central location for listening to customer and assessing customer satisfaction.

For example, the CEC 20 generates a user interface (e.g., graphical user interface (“GUI”)) that an organization can use to manage feedback. For example, the user interface generated by the CEC 20 can be configured to allow an organization to create and manage surveys and other feedback mechanisms, view customer feedback (e.g., survey results, ratings, etc.), respond to customer feedback (e.g., publicly or privately), and view reports. In particular, the CEC 20 allows organizations to listen and promote. For example, the CEC 20 allows organization to listen to customers by monitoring customer satisfaction, capturing real-time feedback, issuing surveys (e.g., rewards-based surveys), following social media (including social media messages), analyzing demographics about customers and employees, and generating reports (e.g., enterprise reports). Similarly, the CEC 20 allows organizations to promote by publishing unlimited personalized content in a variety of formats such as video and rich content graphics. Personalized content can include digital promotions and offers, multi-media content (e.g., digital media), and real-time customer messaging.

For example, the CEC 20 can create campaigns, including but not limited to, surveys, promotions, offers, trivia, assessment, and cross-campaigns, which can be published by the CEC 20. The CEC 20 allows an organization to create content and publish content for a campaign using one or more of the channels 40. In some embodiments, a campaign, such as a promotion, can be customized or tailored for a specific customer or type of customer. For example, a campaign can be tailored based on a customer's demographics (e.g., gender, age range, marital status, income range, household size, education level, and profession), customer's preferences (e.g., hobbies and interests), events (e.g., sporting events, conferences, and concerts) attended by a customer, and/or current or past physical locations (e.g., state, region, city, buildings, etc.) visited by a customer. In some embodiments, the CEC 20 can be configured to automatically import physical location information from external sources (e.g., a customer's smart phone or mobile device, location information provided through social media, cookie information, customer or attendee lists, etc.) or an authorized individual can manually input physical location information to the CEC 20.

In some embodiments, a campaign can also be tailored based on a customer's prior feedback (e.g., submitted survey answers, prior promotions viewed, prior offers claimed, prior offers redeemed, prior trivia results, or prior assessment results). Customer feedback can include the customer's demographics, a customer's preferences, events attended by the customer, current or past physical locations visited by the customer, prior responses or interactions with an organization (e.g., ratings, positive or negative feedback, etc.). For example, in some embodiments, a campaign can be associated with criteria established by the organization through the CEC 20. When received customer feedback satisfies criteria for the campaign (e.g., matches), the CEC 20 sends the campaign to the customer providing the feedback. The criteria can include a type of feedback (e.g., survey answers or trivia answers), a type of indirect customer feedback (e.g., usage information), a customer demographic (e.g., gender, marital status, household size, salary, geographic location, etc.), a customer preference, a geographic location associated with the organization visited by the customer, an event associated with the organization attended by the customer, and the channel on which the feedback was collected.

As noted above, the CEC 20 allows an organization to publish or push content to one or more channels 40. In some embodiments, the CEC 20 automatically (e.g., triggered by feedback criteria) pushes created content to a channel 40 (e.g., a mobile application). In other embodiments, the CEC 20 creates a link for created content, which an organization can manually add to a channel 40. In some embodiments, the CEC 20 automatically pushes promotions to a third-party mobile application that tracks the activities of the organization and potentially other organizations (e.g., organizations located geographically close to the customer or previously tagged by the customer as being of interested). The mobile application can be configured to receive the promotion and automatically alert or notify a customer of the promotion. In some embodiments, the organization can also specify what customers are alerted by the mobile application (e.g., based on a demographic or specific customer feedback). The mobile application can also be configured to receive feedback from the customer, which can be provided to an organization through the CEC 20. Furthermore, the mobile application can be configured to provide a response or message to a customer (e.g., a private response to customer feedback) from an organization (e.g., entered through the CEC 20).

Content published by an organization (e.g., through the CEC 20) can be called “campaigns,” and campaigns can be categorized as a survey campaign, a promotion campaign, a trivia campaign, an assessment campaign, and cross-campaigns. A survey campaign can include a survey and optionally, a survey reward and can be published from the CEC 20 to various channels 40 (e.g., provided as link on the organization's website). The survey can include questions regarding a customer's opinion of the organization. Survey results are captured in the CEC 20 and made available to the organization and can also be used by the CEC 20 to generate reports. In some embodiments, survey results can be filter or sorted within the CEC 20 (e.g., by a specific demographic, preference, location, event, and/or feedback category). If a survey reward is provided for completing the survey, the reward can be displayed and redeemed by the customer through a channel 40, direct correspondence (e.g., a mailing or email), or a combination thereof.

A promotion campaign can include one or multiple promotions that provide special offers. As noted above, a promotion can be published by the CEC 20 to one or more channels 40. A promotion can include something used to raise awareness (e.g., customer awareness) of an organization (e.g., the organization itself, an event provided by the organization, a product or service provided by the organization, a specific location of the organization, etc.) In some embodiments, a customer can receive a promotion through a mobile application that allows the customer to see and redeem available promotions. The mobile application can also track redeemed promotions. Promotion views, claimed offers, and redeemed offers can be captured in by the CEC 20 and viewed by organizations (e.g., in a report). Similar to a survey campaign, data associated with promotion campaigns can be filtered and sorted within the CEC 20 (e.g., by a specific demographic, preference, location, event, and/or feedback category).

A trivia campaign can include one or more trivia questions and one or more rewards and can be published by the CEC 20 to one or more channels 40. For example, a customer can access and complete trivia questions posted on an organization's social media website. The CEC 20 can collect the responses and provide rewards accordingly. In some embodiments, the awards can be based on the answers to the trivia questions (e.g., a percentage correct). In other embodiments, all customers submitting answers to the trivia questions can receive an award. Also, in some embodiments, a customer can choose his or her reward. In addition or alternatively, a customer can accumulate points for completing trivia campaigns, which can later be exchanged for rewards. Also, in some embodiments, the submitted answers can be used as a submission for a contest with random or non-random entries selected for rewards. Rewards can be provided through the channels 40 (e.g., by the CEC 20), through direct correspondence, or a combination thereof. Data regarding the trivia questions completed, the rewards issued, and the rewards redeemed can be captured by the CEC 20 and made available to organizations (e.g., in a report). Similar to survey and promotion campaigns, data associated with trivia campaigns can be filtered and sorted within the CEC 20 (e.g., by a specific demographic, preference, location, event, and/or feedback category).

An assessment campaign can include an evaluation of a specific product, service, individual, location, or organization and optionally can be associated with one or multiple rewards. Assessment campaigns can be published by the CEC 20 to one or more channels 40. The evaluation can be based on at least one metric, including but not limited to a quality of a product, service, employee, location, channel, and/or information associated with an organization (e.g., overall rating, speed, professionalism, cleanliness, employee service, value, quality of service, quality of a product, quality of channels, reputation of an organization, quality of a promotion, and an atmosphere). For example, in some embodiments, a customer can use a mobile application to complete and submit evaluation questions. A reward can be offered in response to submission of an evaluation, which can be offered through the channels 40 (e.g., by the CEC 20), by direct correspondence, or a combination thereof. Also, in some embodiments, points can be offered as a reward, which can be accumulated and traded for rewards. Data regarding the evaluations completed, the rewards issued, and the rewards redeemed can be captured by the CEC 20 and made available to organizations (e.g., in a report). Similar to survey, promotion, and trivia campaigns, data associated with assessment campaigns can be filtered and sorted within the CEC 20 (e.g., by a specific demographic, preference, location, event, and/or feedback category).

In cross-campaigns, the CEC 20 can link one or more campaigns together. Cross-campaigns allow organizations to create continuous intelligent engagement opportunities with customers. The linking of campaigns together can be performed by an authorized individual through the CEC 20. In some embodiments, cross-campaigns can be generated dynamically based on the results of previous campaigns. For example, a customer can complete a survey, and, based on the customer's survey responses, the customer can be presented with specific promotions. In another example, a customer can claims a specific offer, and, based on the offer that was claimed, the customer can be presented with another survey.

It should be understood that the campaigns managed through the CEC 20 can include various types of content including textual content, graphical content, video content, audio content, image content, and combinations thereof.

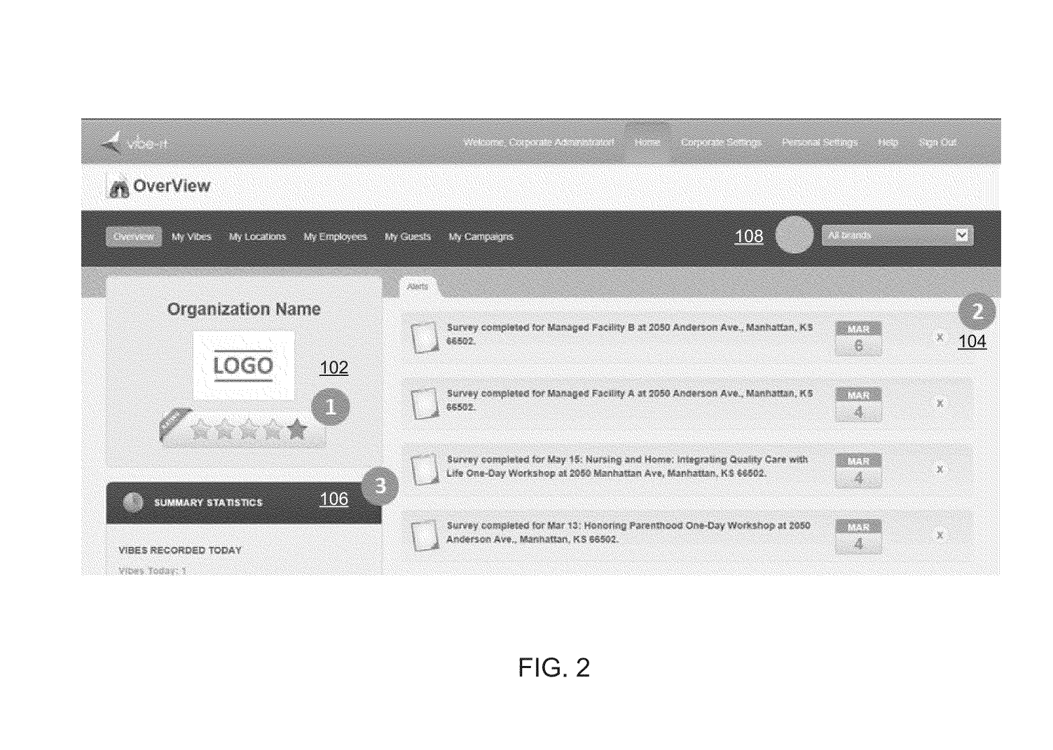

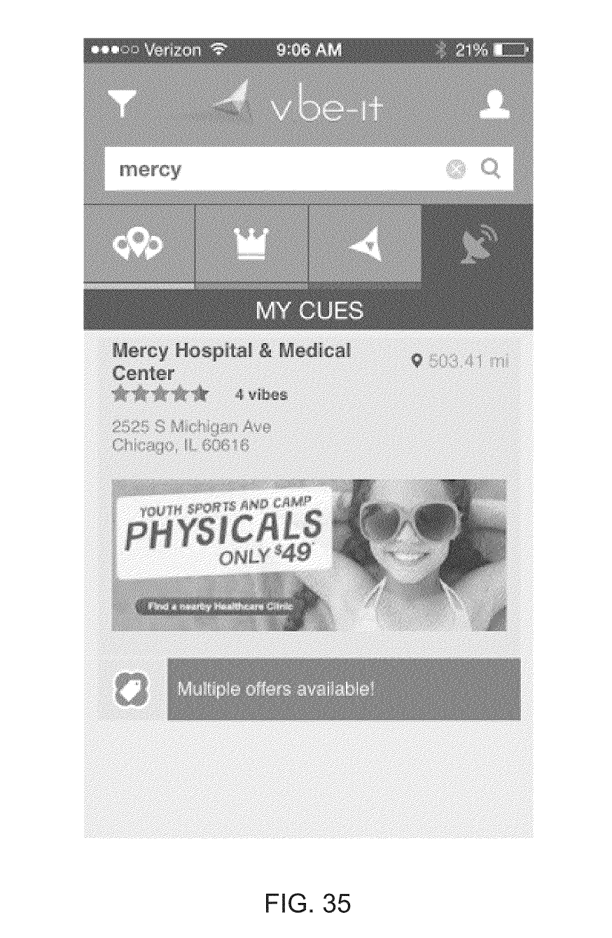

Accordingly, as described above, the CEC 20 collects customer feedback associated with an organization from numerous channels 40 and makes the collected feedback available to authorized users associated with the organization to assess customer satisfaction. In particular, the CEC 20 can generate user interfaces (e.g., GUIs) accessible by authorized users through a user device 30. The user interfaces allow users to design and publish campaigns, view collected feedback (generated in response to a published campaign or independent to any published campaign), and respond to collected feedback. For example, FIGS. 2-48 illustrate user interface provided by the CEC 20. Users can access the user interfaces by logging into the CEC 20 (e.g., by providing a username and password or other authorizing information). In some embodiments, the functionality provided by the CEC 20 to a particular user can be based on access permissions assigned to the user.

In particular, after a user logs into the CEC 20, the user can access an overview tab, as illustrated in FIG. 2. The overview tab can include an overall rating for a location 102, real-time alerts regarding campaigns 104, and periodic (e.g., daily) reports and/or statistics 106. The real-time alerts can be associated with a completed survey, positive or negative employee feedback, and/or customer service ratings for a location exceeding or falling below a specified level. Selecting a displayed alert allows a user to view more details regarding an alert. The overview tab can also include a dropdown box 108 that allows a user to filter ratings, reports, surveys, and promotions (e.g., based on a selected brand).

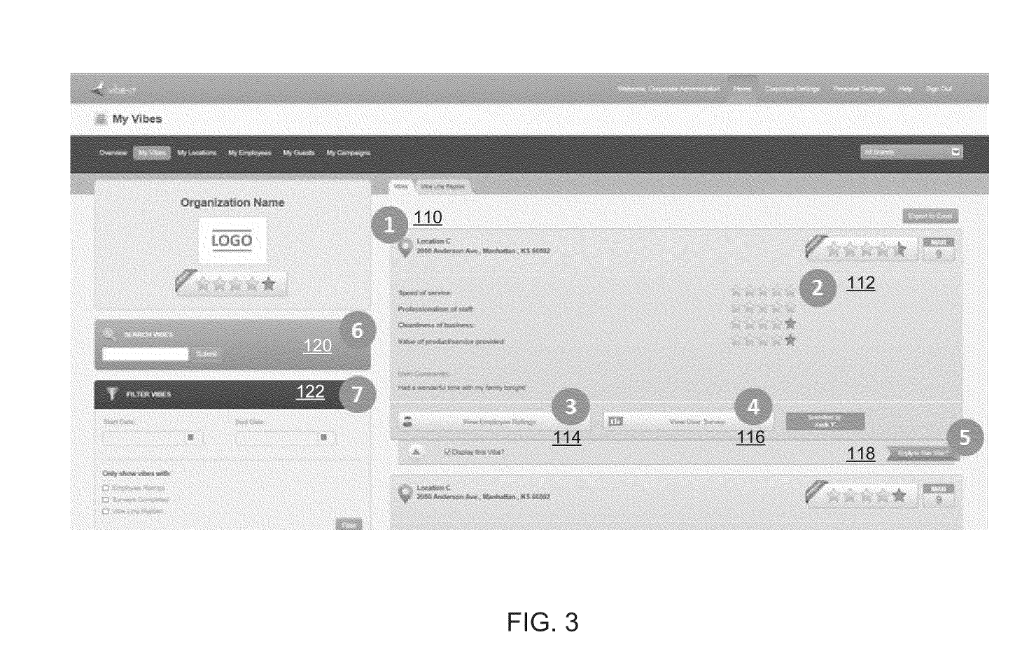

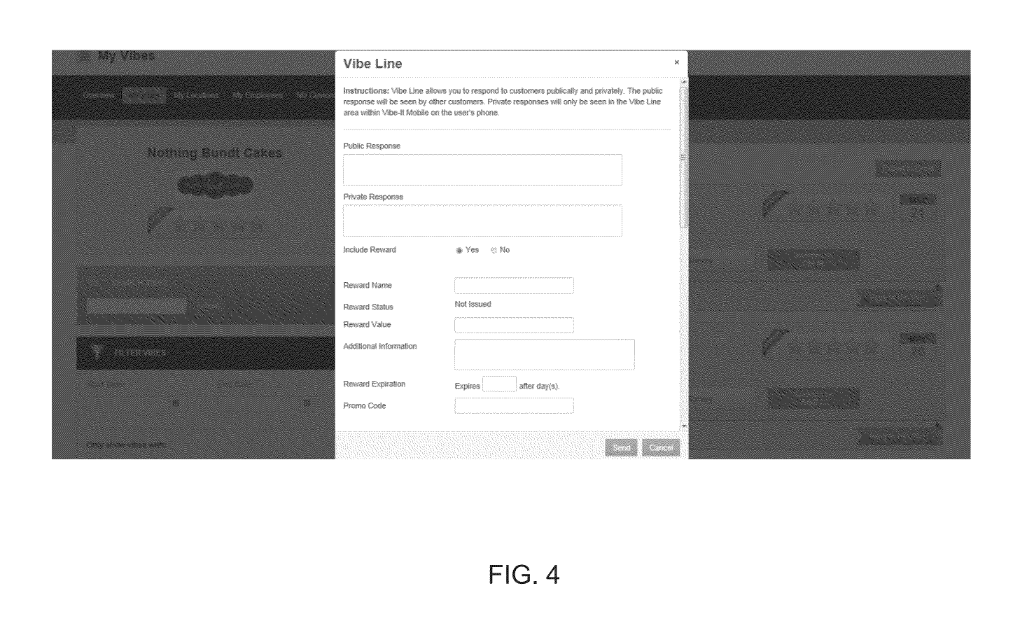

The CEC 20 also provides a ratings tab for reporting ratings for a facility of an organization as illustrated in FIG. 3. The ratings tab illustrates a location of the facility 110, detailed ratings and comments 112, feedback on employees 114, individual survey results 116, public or private responses 118, a search bar 120, a filter section 122, and overall ratings (referred to as “start” ratings in the use interfaces). In some embodiments, the filter section 122 allows a user to filter displayed data based on a date range, employee ratings, survey completions, responses (e.g., instant messaging), and/or specific overall ratings. In some embodiments, a customer provided feedback can indicate that he or she does not want to be contacted in a response. As illustrated in FIG. 4, in these embodiments, an indicator, such as a red box stating “No Contact,” can be displayed next to displayed customer feedback to alert the user not to respond to the feedback. In some embodiments, the CEC is also configured to automatically prevent a response from being sent to a customer providing feedback, when the indicator is displayed for the feedback.

The CEC 20 also provides a user interface for generating public and private responses to customer feedback as illustrated in FIG. 4. A public response is displayed to customers other than just the customer who provided the feedback, and a private response is displayed only to the customer who provided the feedback. In some embodiments, a private response can be display as a message within a mobile application used by the customer. A reward can also be selected as a part of a response by selecting a reward name, value, terms and conditions, expiration date, and/or promotion code for redemption.

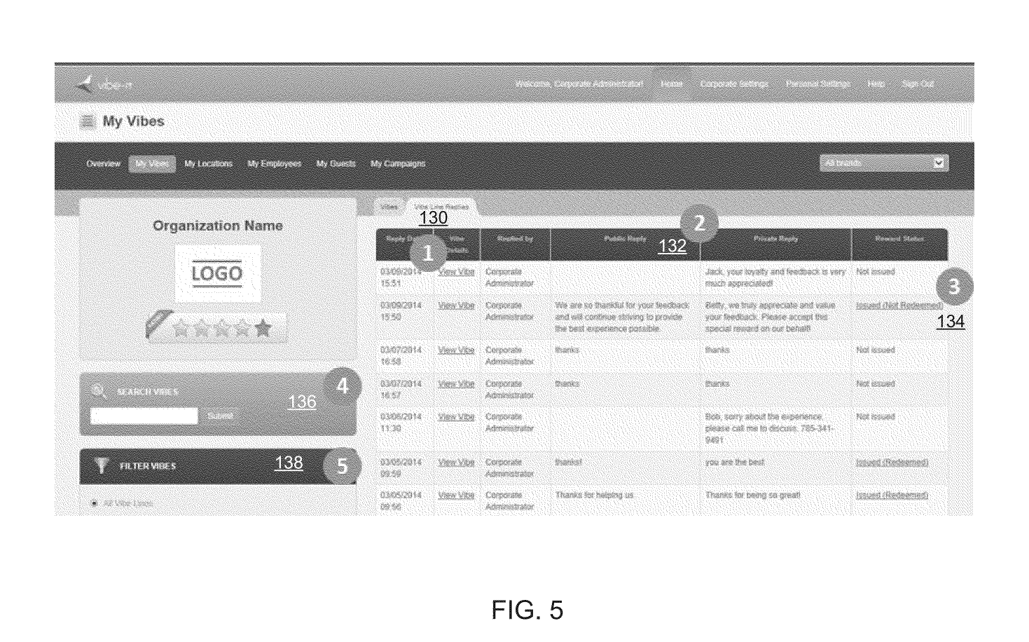

The CEC 20 also provides a replies tab that reports responses sent to particular feedback, as illustrated in FIG. 5. The replies tab displays a customer's rating and comments 130, an organization's public and/or private responses 132, a reward that was offered 134, a keyword search box 136 (e.g., allowing a user to search by name, public response, and private response), and a filter box 138 (e.g., allowing a user to filter based on responses and rewards).

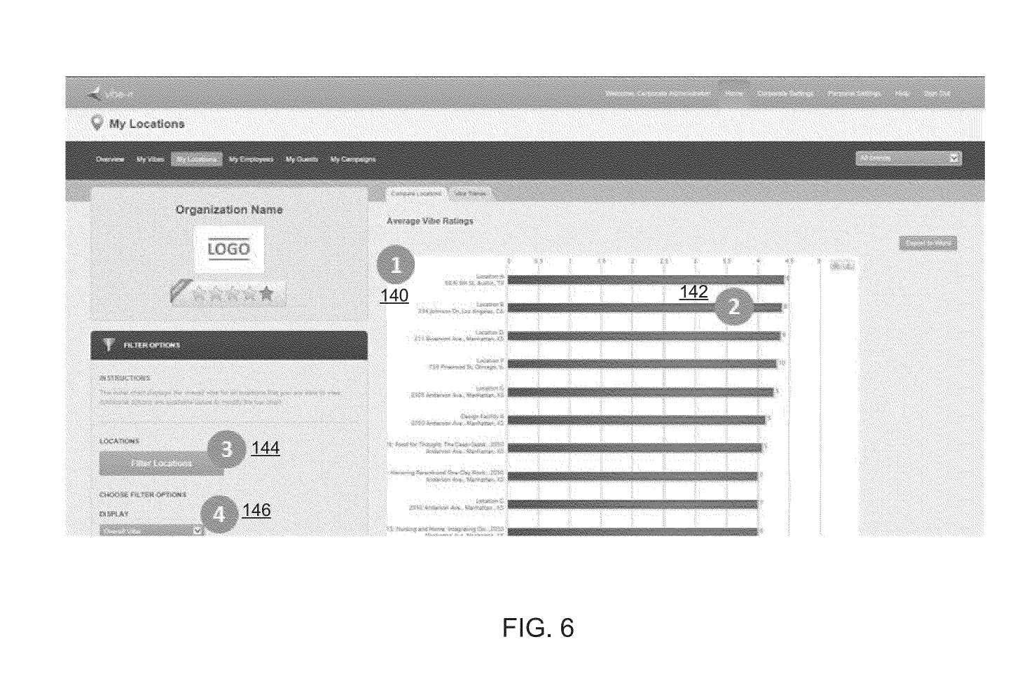

The CEC 20 also provides a compare locations tab as illustrated in FIG. 6. The compare locations tab illustrates how a location is are performing based on an average rating and a total number of ratings 140. A bar 142 can be selected to view details of ratings, and a selection box 144 can be used to select a specific location for a report. A display box 146 can be used to perform additional changes to displayed data including modifying the chart's display (e.g., overall rating, speed, professionalism, cleanliness, or value), scope (e.g., location, brand, location owner, location manager, or state), duration (e.g., last 30 days, 3 months, 6 months, or 12 months), sorting, and benchmarks (e.g., average or goals) shown on the graph.

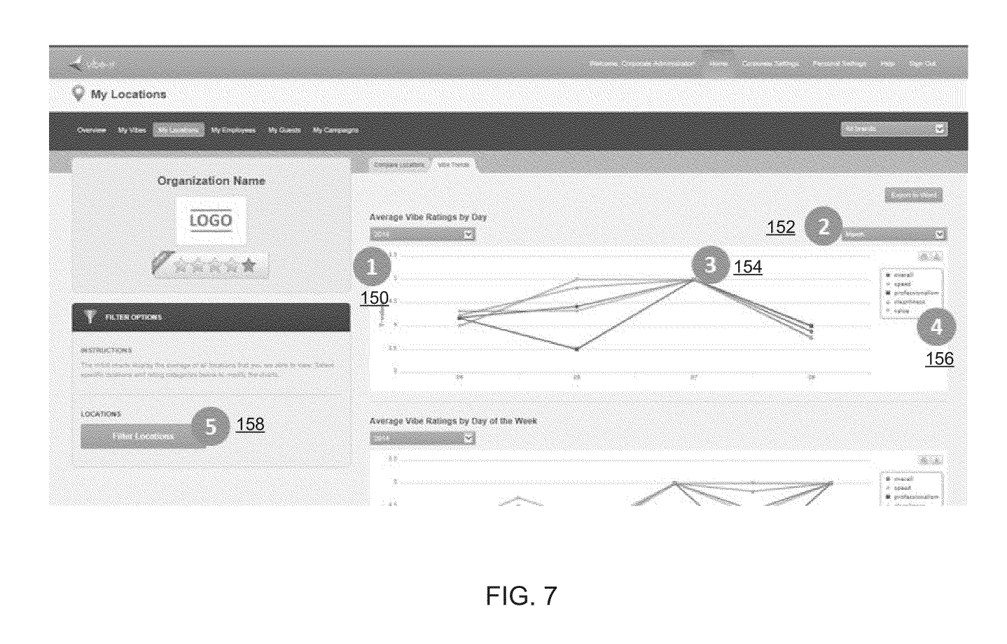

The CEC 20 also provides a trends tab as illustrated in FIG. 7. The trends tab illustrates how various locations are performing based on daily, weekly, and monthly trend results. The trends tab also allows a user to select specific months and years for trend reports 152, select a specific day or month on a line chart to view details for specific rating 154, to remove (de-select) and add (select) lines from a line chart using a legend 156 (or remove or add lines from all line charts with a single selection or de-selection), and select specification locations for reporting using a selection box 258.

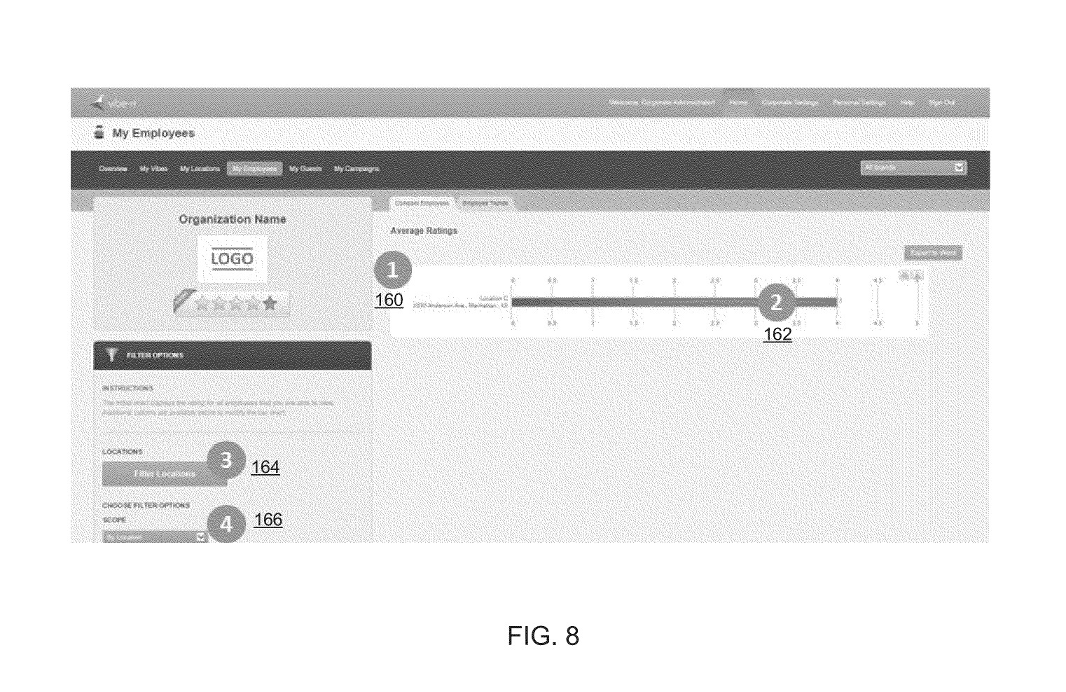

The CEC 20 also provides a compare employees tab as illustrated in FIG. 8. The compare employees tab illustrates how a location is performing based on an average employee rating 160. The compare employees tab also allows a user to select a bar 162 on a bar chart to view detailed ratings and comments about an employee, select specific locations for a report using a locations box 164, and perform to select specific locations for the report, and use a display box 166 to perform additional filtering of employee ratings including modifying the chart's scope (e.g., location, brand, location owner, location manager, or state), duration (e.g., last 30 days, 3 months, 6 months, or 12 months), sorting, and benchmarks (e.g., average or goals) shown on a chart.

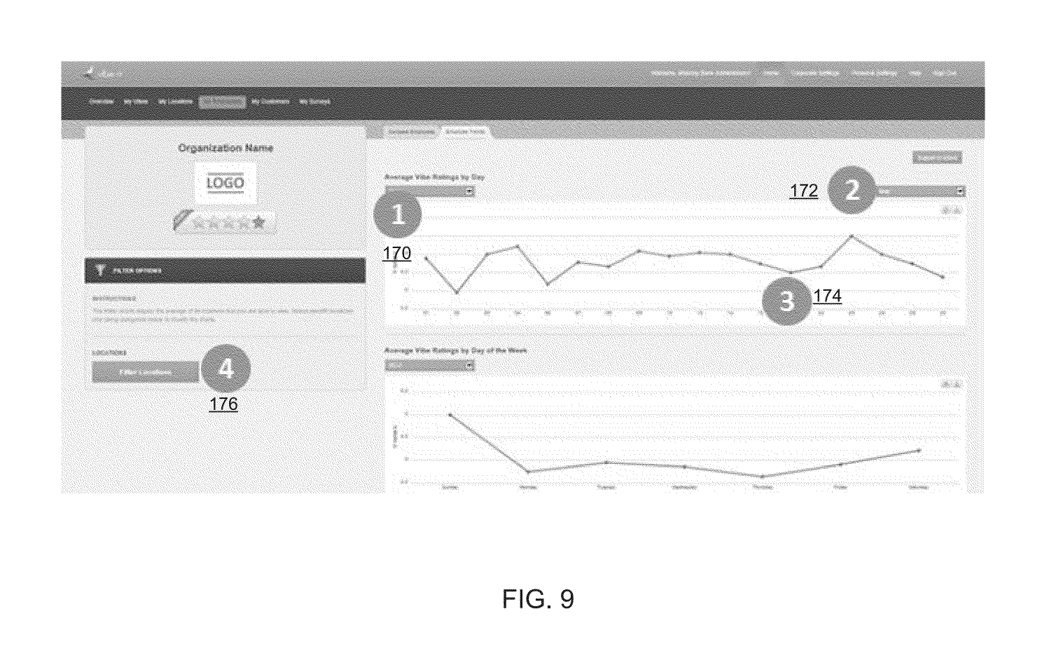

The CEC 20 also provides an employee trends tab as illustrated in FIG. 9. The employees trend tab illustrates how various locations' employees are performing based on daily, weekly, and monthly trend results 170. The employees trend tab also allows a user to select specific months and years for a trend report 172, to select a specific day or month on a line chart to view detailed employee ratings 174, and use a locations box 176 to select specific locations for a report.

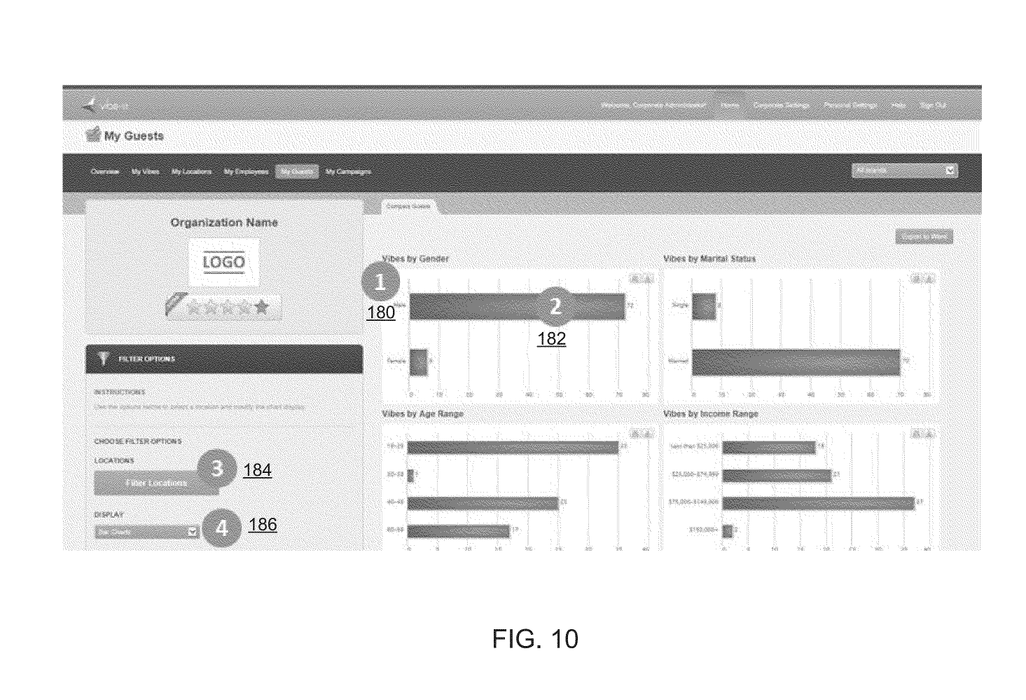

The CEC 20 also provides a guests tab as illustrated in FIG. 10. The guests tab illustrates results across multiple demographics 180. A user can select a displayed demographic 182 to view detailed ratings and comments provided by the selected demographic. A user can also use a locations box to select a specific location for a report 184 and use a display box 186 to perform additional changes to displayed data including modifying the chart's display (e.g., bar chart, pie chart, or scatter plot) and duration (e.g., day, week, month, or multiple months).

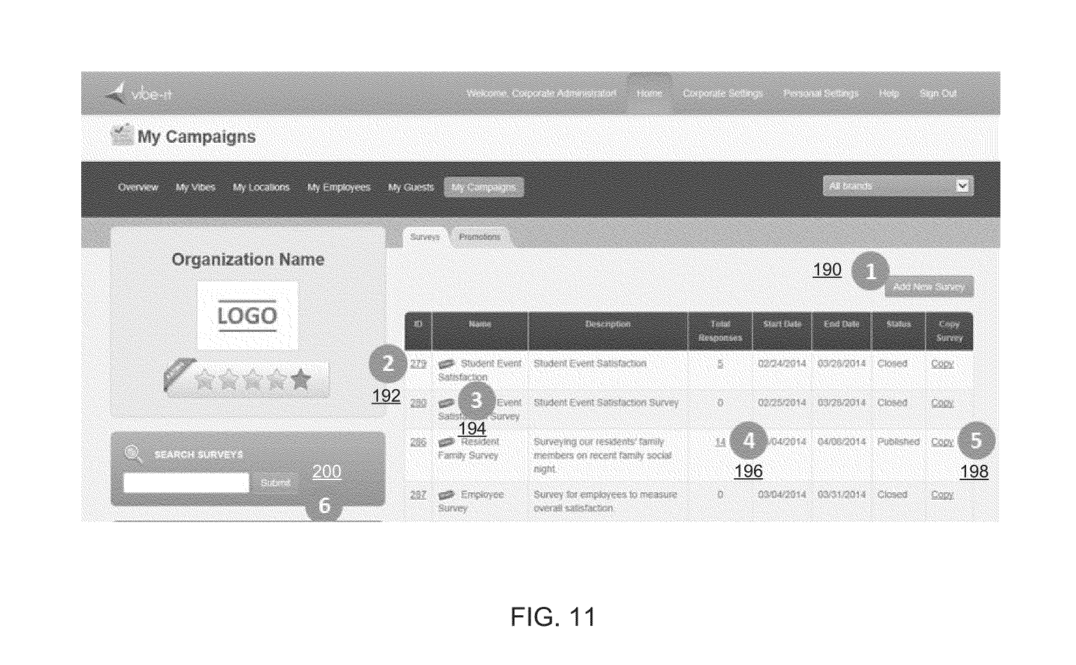

The CEC 20 also provides a surveys tab as illustrated in FIG. 11. From the surveys tab, a user can add a new survey using a mechanism 190, view existing survey details by selecting a displayed survey 192, view reward results by selecting a reward tag 194, view survey results by selecting the number in a total responses column 196, view a copy of a survey by selecting a copy mechanism 198, and filter surveys using a key word search mechanism 200. If a survey is published, a green indicator tag can be displayed next to the survey. For example, surveys can include three statuses: draft, published, and closed. A draft survey is a survey that is currently being worked on but has not yet been published. A draft survey can be edited as many times as needed until it is published or closed. A published survey is a survey that has been published. In some embodiments, survey details (e.g., questions) may no longer be edited once a survey has been published. A closed survey is a survey that has been closed either manually by an authorized user or automatically by the CEC 20. For example, surveys can be closed automatically if an end date specified for a survey is reached (e.g., 11:59 PM on the selected date) or if a survey limit has been reached.

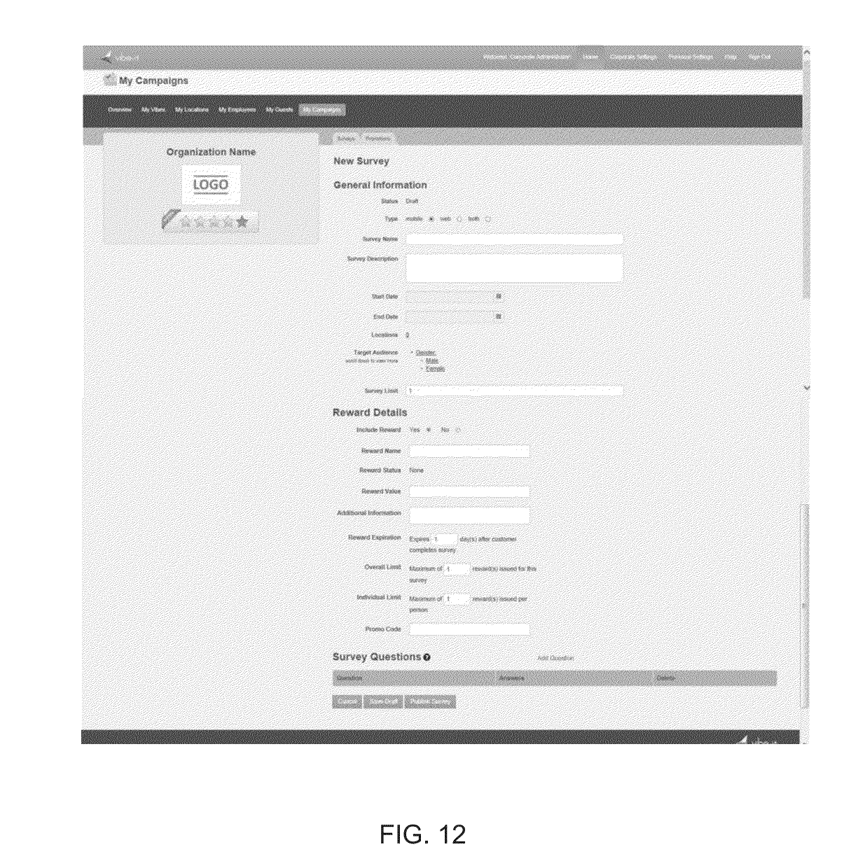

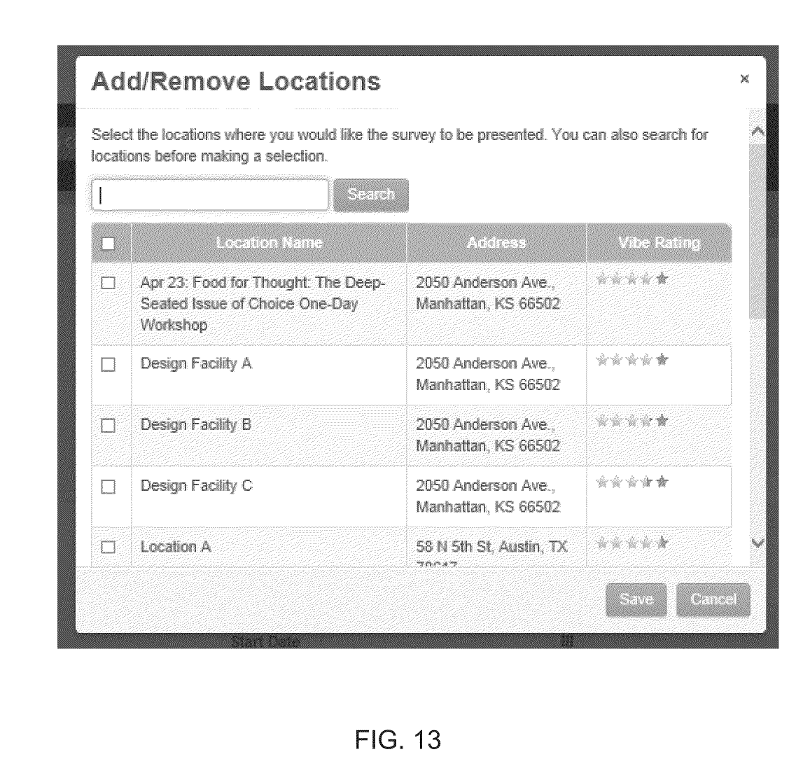

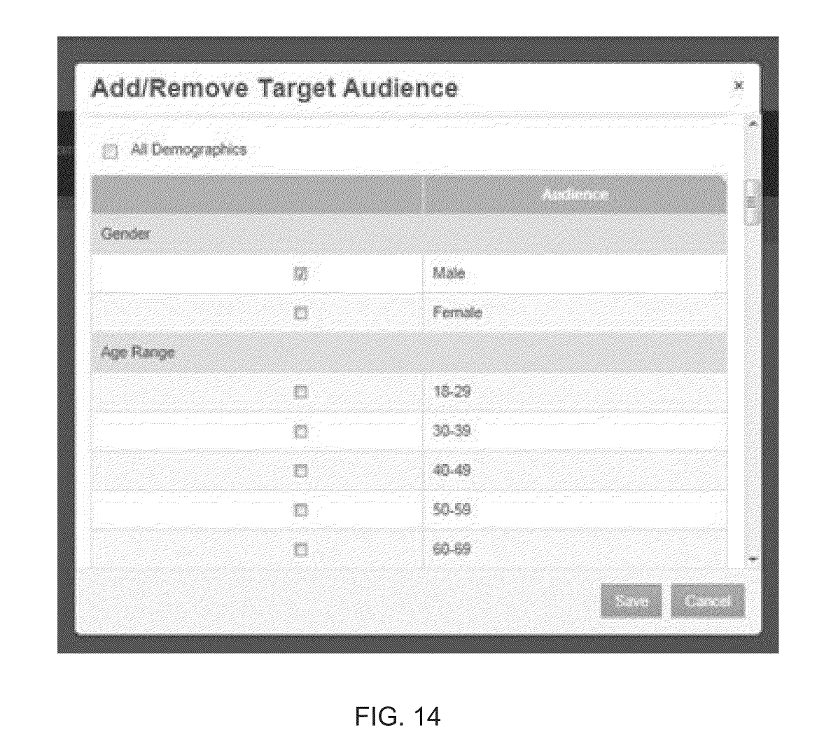

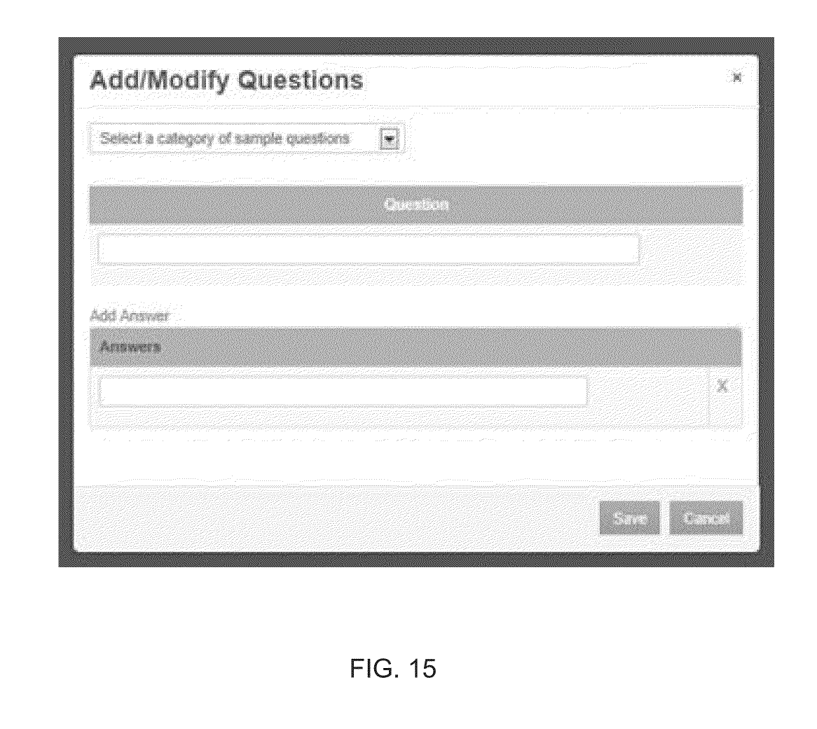

The CEC 20 also provides an add new survey tab as illustrated in FIG. 12. The add new survey tab can display a status (e.g., draft, published, or closed), type (e.g., web published including a link or application published), survey name, survey description (e.g., instructions to survey respondents), start date, end date, location, target audience (e.g., demographic or preference), survey limit (e.g., total number of surveys), included reward (e.g., basic reward or “chance to win” an award), reward name, reward status (e.g., not issued, issued and redeemed, or issued but expired), reward value, additional information (e.g., terms and conditions for the reward), reward expiration (e.g., automatically removes on expiration), overall limit (e.g., total number of allowable rewards for the survey), individual limit (e.g., total number of rewards per individual), and promotion code (e.g., added to another system or webpage for redemption) for a survey. FIG. 13 illustrates an add/remove locations popup screen accessible from the add new survey tab, FIG. 14 illustrates an add/remove target audience popup screen accessible from the add new survey tab, and FIG. 15 illustrates an add/remove questions popup screen accessible from the add new survey tab. FIGS. 14 and 15 illustrate examples of criteria that can be used to determine whether to send a survey (or any type of campaign) to a particular customer. Also, as illustrated in FIG. 15, in some embodiments, the add/remove questions popup screen displays a list of available questions, which a user can select by category or filter in various ways.

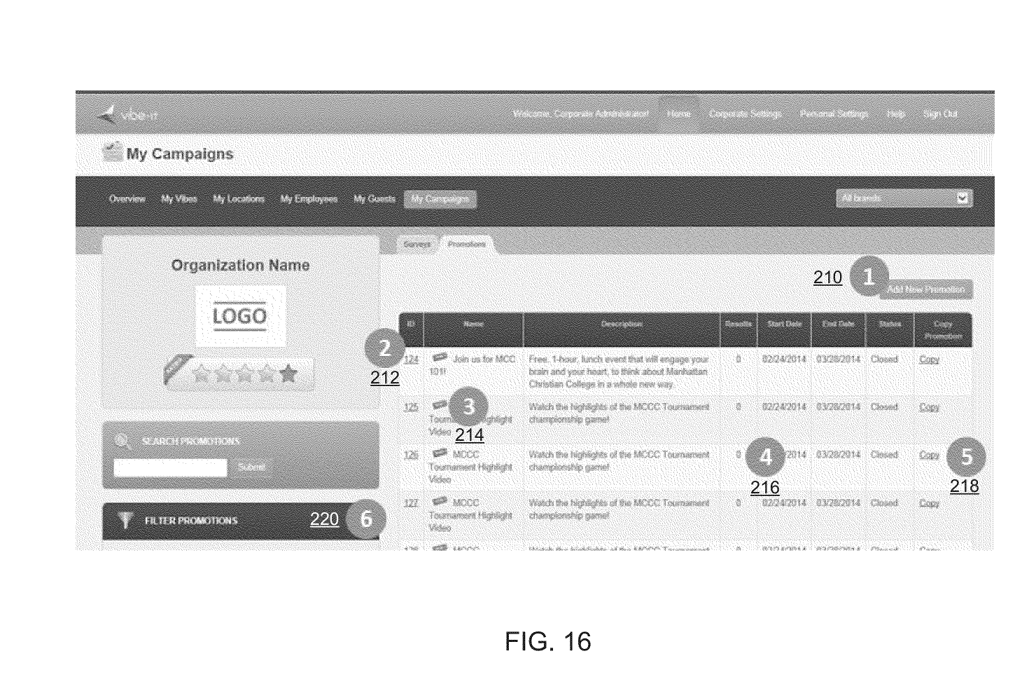

The CEC 20 also provides a promotions tab (or a campaigns tab) as illustrated in FIG. 16. From the promotions tab, a user can add a new promotion using a mechanism 210. Alternatively, a user can view details of an existing promotion by selecting a displayed promotion 212 and view promotion offers by selecting an offer tag 214. A user can view promotion results by selecting a number in the results column 216. A user can also view a copy of the promotion by selecting a copy mechanism 218. A user can also filter promotions (e.g., by fields or key words) using a mechanism 220. In some embodiments, like surveys, promotions can include three statuses: draft, published, and closed and the status of a promotion can be displayed within the promotions tab.

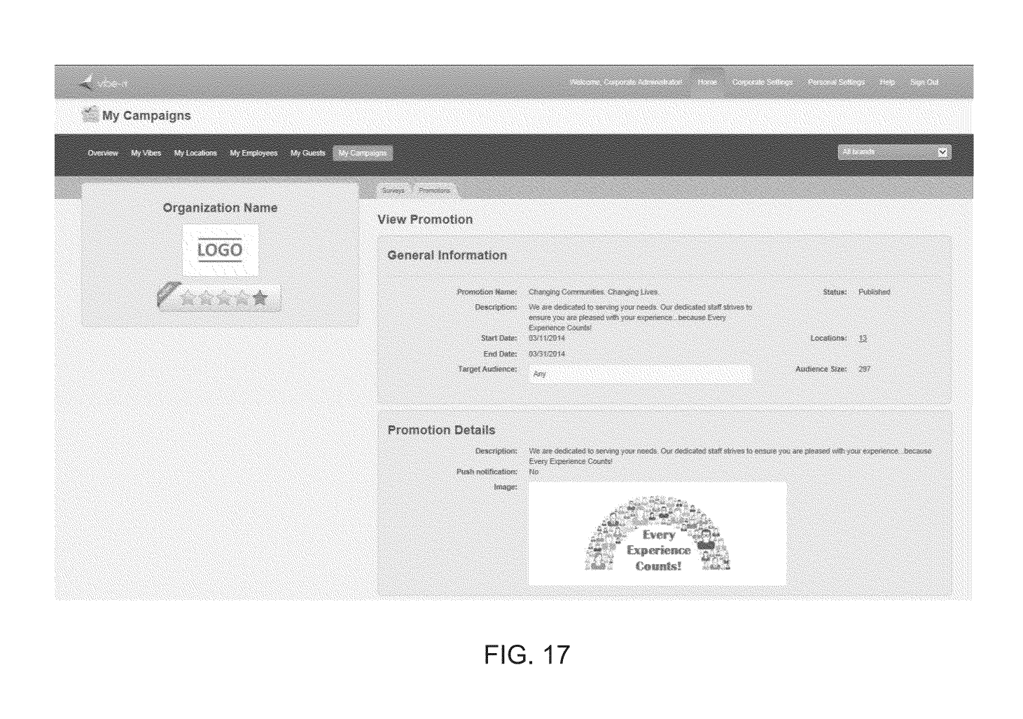

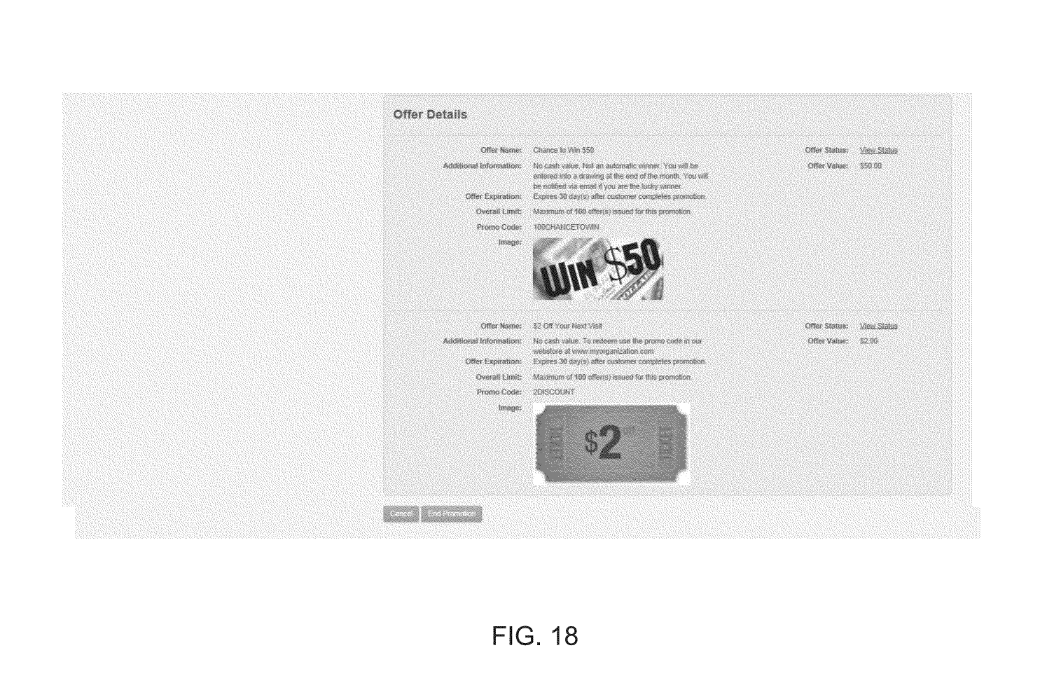

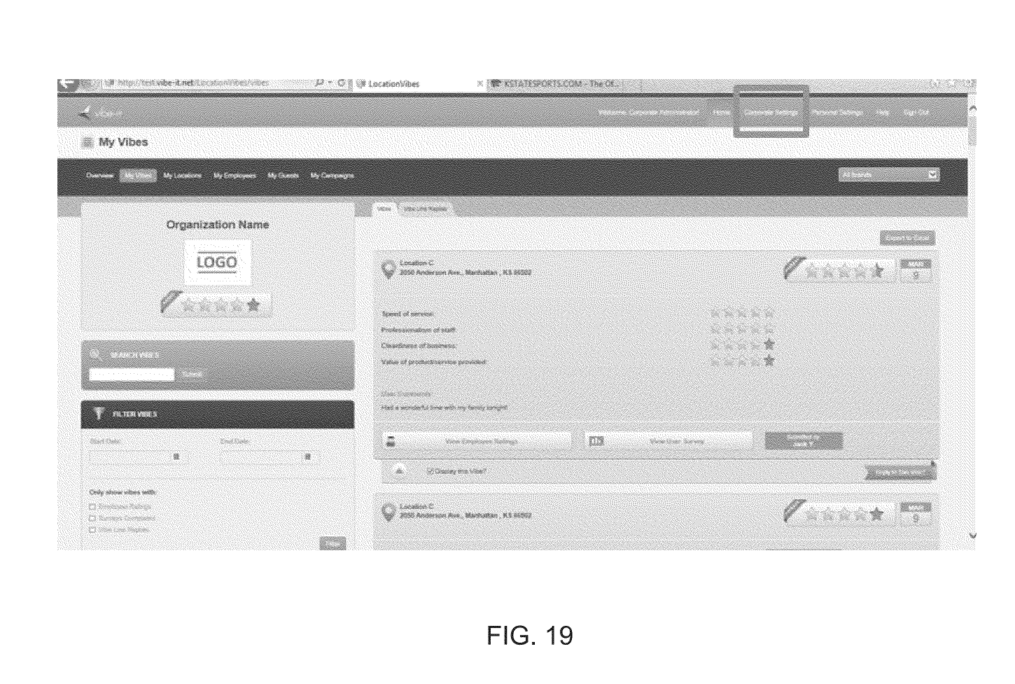

The CEC 20 also provides a view promotions tab (or an add new promotions tab) as illustrated in FIG. 17. Like the add new survey tab, the add new promotions tab can display a status (e.g., draft, published, or closed), promotion name, promotion description, start date, end date, location, target audience (e.g., demographic or preference), audience size (e.g., estimated number of people who may see the promotion based on the target audience selected), promotion code (e.g., added to another system or webpage for redemption), promotion or offer image (e.g., image dimension), push notification, offer name, offer status (e.g., not issued, issued and redeemed, or issued but expired), offer value, additional information (e.g., terms and conditions for the offer), offer expiration (e.g., automatically removes on expiration), and overall limit (e.g., total number of allowable offers that can be claimed) of a promotion. Similarly, FIG. 18 illustrates an offer details window providing promotion offer details, which can be accessible from the view promotions tab.

The CEC 20 also provides a corporate settings window as illustrated in FIG. 19. Using the corporate settings window, a user can manage user accounts for the CEC 20, update information about a location, upload an organization's logo or other branding information (e.g., so that the branding information is displayed within the CEC 20 or campaign content created through the CEC 20), generate benchmarks for the organization (e.g., by brand and/or by location), and view administrative reports including usage reports of the CEC 20 tracking responses sent, surveys created, and users who log into the CEC 20. The corporate settings window can include corporate settings tabs that provide information on users, locations, brands, appearance and benchmarks, and administrative reports. In some embodiments, the tabs displayed or accessible by a particular user can be on the permissions granted to the user by the organization's corporate administrator and/or systems administrator. For example, if a user is a location owner, the user may only be able to view user information and administrative reports. However, if the user is a location manager, the user may only be able to view user information.

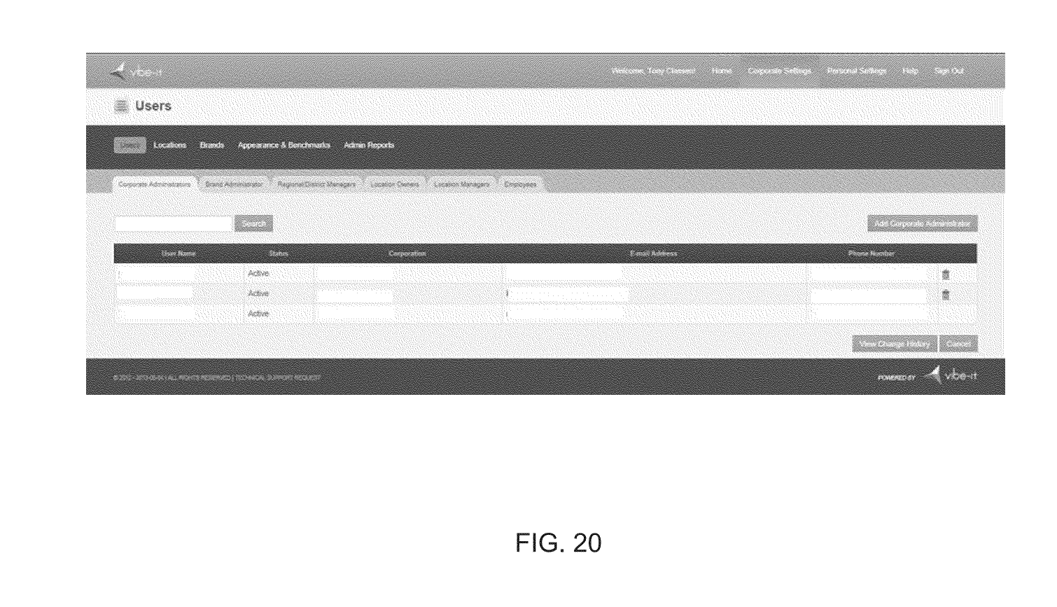

The CEC 20 also provides a corporate administrator users tab as illustrated in FIG. 20. The corporate administrator users tab can allow a user add administrator users for an organization. For example, in some embodiments, users of the CEC 20 can include corporate administrators, brand administrators, regional or district managers, location owners, location managers, and employees. A location manager is a user type who manages at least one organizational location and, therefore, in some embodiments, can view ratings, surveys, and promotions for the assigned location, send responses, create and publish surveys and promotions, and add and edit employee within the CEC 20. A location owner is a user type who oversees at least one organizational location and has the same authorization within the CEC 20 as a location manager plus can manage user accounts for the assigned location including location managers and employees. A regional or district manager is a user type who oversee multiple locations across a region or district and has the same authorizations as a location owner within the CEC 20 plus can establish location benchmarks and manage user accounts for the assigned location including location owner, location managers, and employees. A brand administrator is a user type that has access to information for a particular brand and can view locations, ratings, surveys, and promotions for the assigned brand, send responses, create and publish surveys and promotions, manage user accounts within the brand, establish brand and location benchmarks, and add and modify brand logos within the CEC 20. A corporate administrator is a user type who manages the CEC 20 and has the same authorizations within the CEC 20 as other users. For example, a corporate administrator can view locations, ratings, surveys, and promotions, send responses, create and publish surveys and promotions, manage user accounts and assign access permissions to user accounts, establish corporate, brand and location benchmarks, and add and modify corporate and brand logos.

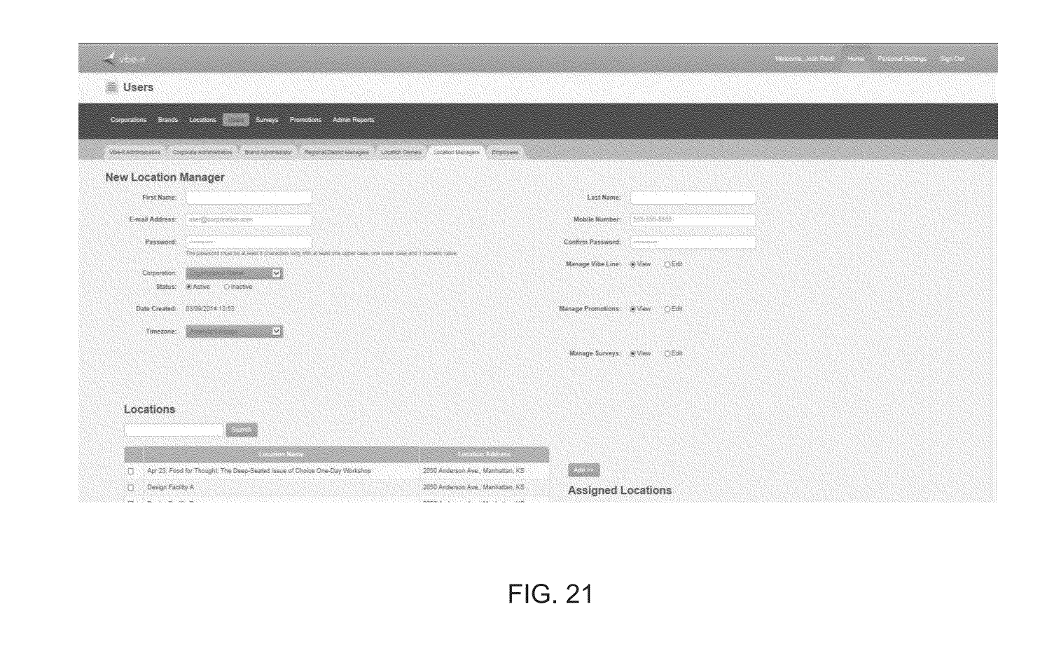

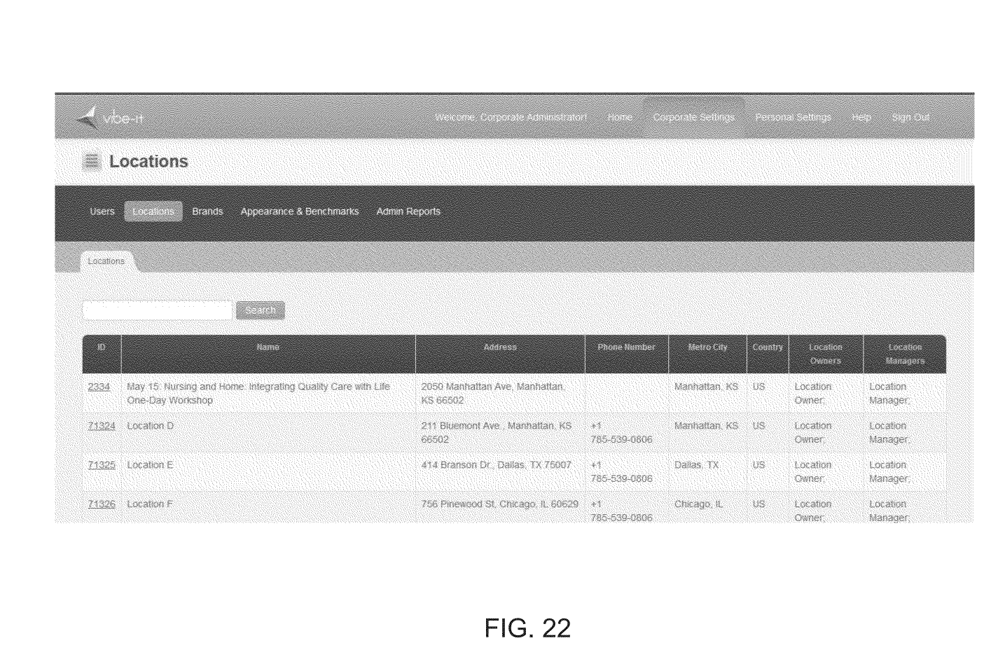

The CEC 20 also provides a location manager users tab as illustrated in FIG. 21. As illustrated in FIG. 21, different authorizations can be assigned to a location manager through the location manager users tab. For example, a user can use a manage responses mechanism to grant a location manager viewing rights to responses and/or editing rights to responses. Similarly, a user can use a manage promotions mechanism to grant a location manager viewing rights to promotions and/or editing rights to promotions and a manage surveys mechanism to grant a location manager viewing rights to surveys and/or editing rights to surveys. In some embodiments, the CEC 20 tracks changes made to a user account, including the date and/or time of a change and an identifier of the user who made the change. The CEC 20 can also track logins to the CEC 20 for particular users including the date and/or time of the log in and length of time the user was logged in. A user can also use the location manager users tab to manage locations associated to a location manager. Once associated with a location, a location manager can access ratings, responses, surveys, and promotions for the location.

The CEC 20 also provides a locations tab as illustrated in FIG. 22. The locations tab allows a user to view business locations within the CEC 20. For example, locations tab includes a list of locations for a particular organization. The list displays information regarding the location owners and location manager.

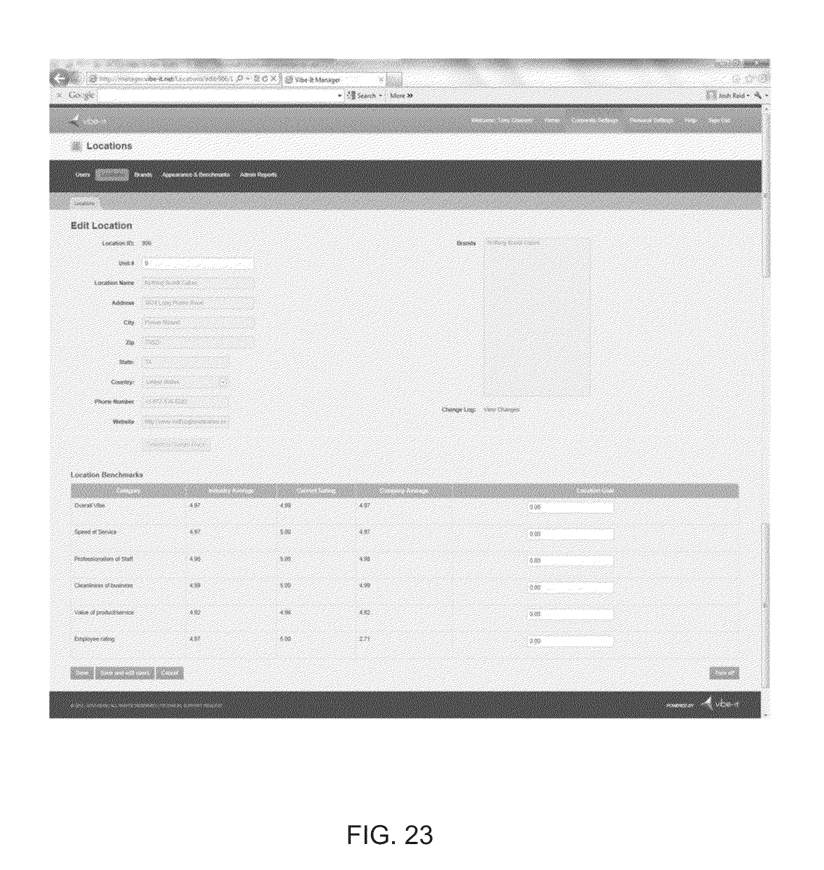

The CEC 20 also provides an edit location tab as illustrated in FIG. 23. The edit location tab allows a user to update information for a location associated with an organization. As illustrated in FIG. 23, different benchmarks or goals can be established for a particular location. The CEC 20 can be configured to automatically generate real-time alerts (e.g., an email) to users associated with a location when the location meets or falls below these benchmarks.

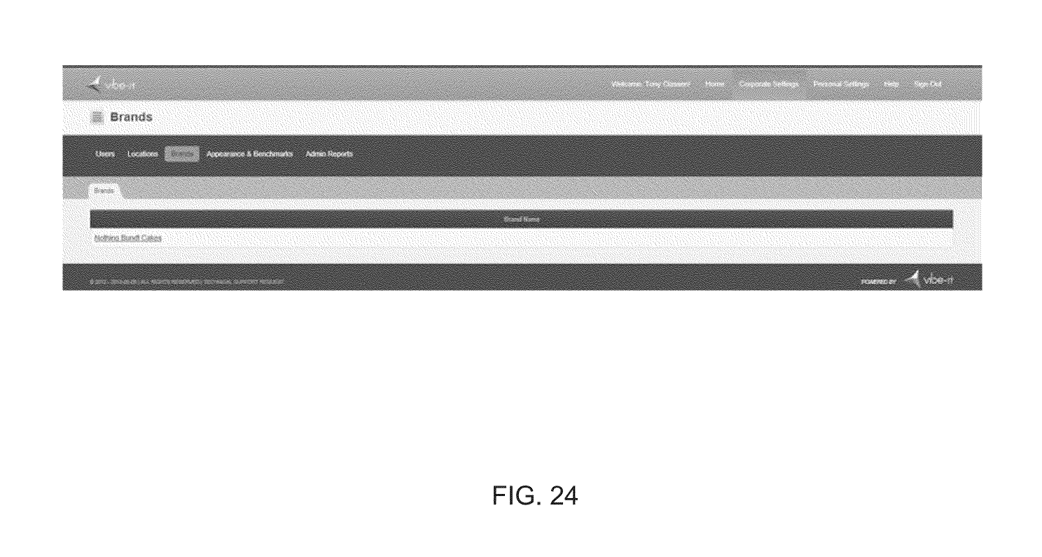

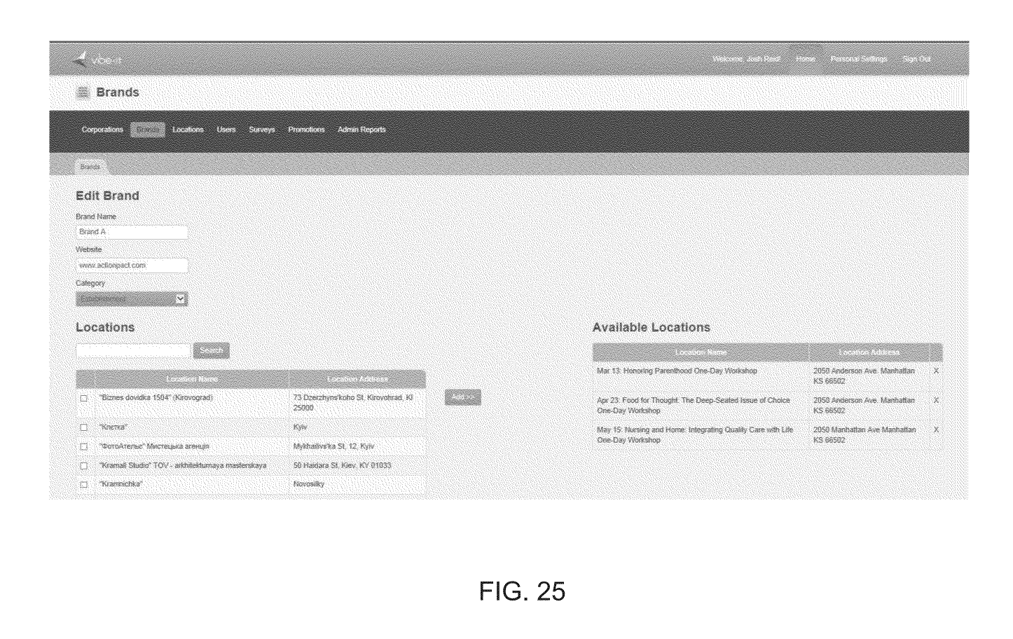

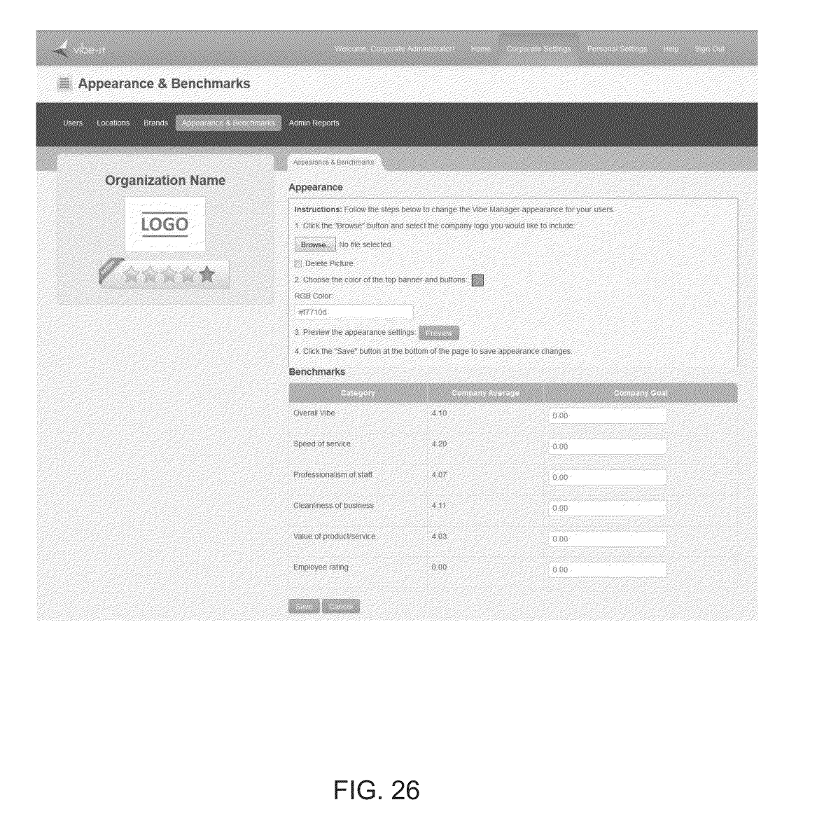

The CEC 20 also provides a brands tab as illustrated in FIG. 24. The brands tab allows a user to update an organization's brand information within the CEC 20. For example, the brands tab can display a list of brands, and FIG. 25 illustrates an edit brands tab that allows edits to be made to a listed brand. In some embodiments, from the brands tab or the edit brands tab, a user can upload an image of the brand's logo, set benchmarks for the brand, and view industry averages for the brand. An industry average column displayed in the brands tab can provide an average score for a brand in various categories within an industry, such as ratings, speed, professionalism, cleanliness, value, and employee ratings. Examples of industries include banking, health care, lodging, dining, etc.

The CEC 20 also provides an appearance and benchmarks tab as illustrated in FIG. 26. The appearance and benchmarks tab allows a user to update general settings for the CEC 20, such as appearance settings and benchmark settings. For example, the appearance fields included in the appearance and benchmarks tab allow a user to upload an organization's logo, and the benchmarks fields included in the appearance and benchmarks tab allow a user to set benchmarks for an organization and compare the benchmarks to actual feedback and/or industry averages.

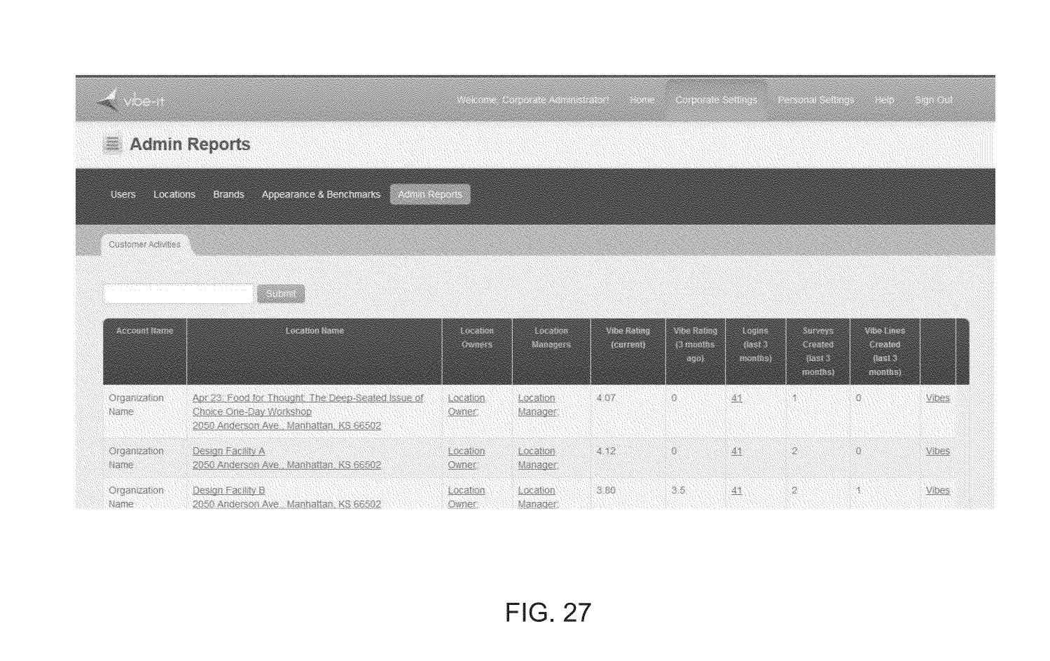

The CEC 20 also provides an administrative reports tab as illustrated in FIG. 27. The administrative reports tab allows a user to view activities for a location. The activities can include a location's current overall rating, an organization's overall rating at some time in the past (e.g., three months ago), a number of logins at a location, a number of surveys created at a location, a number of feedback responses from a location, and actual feedback responses for a location.

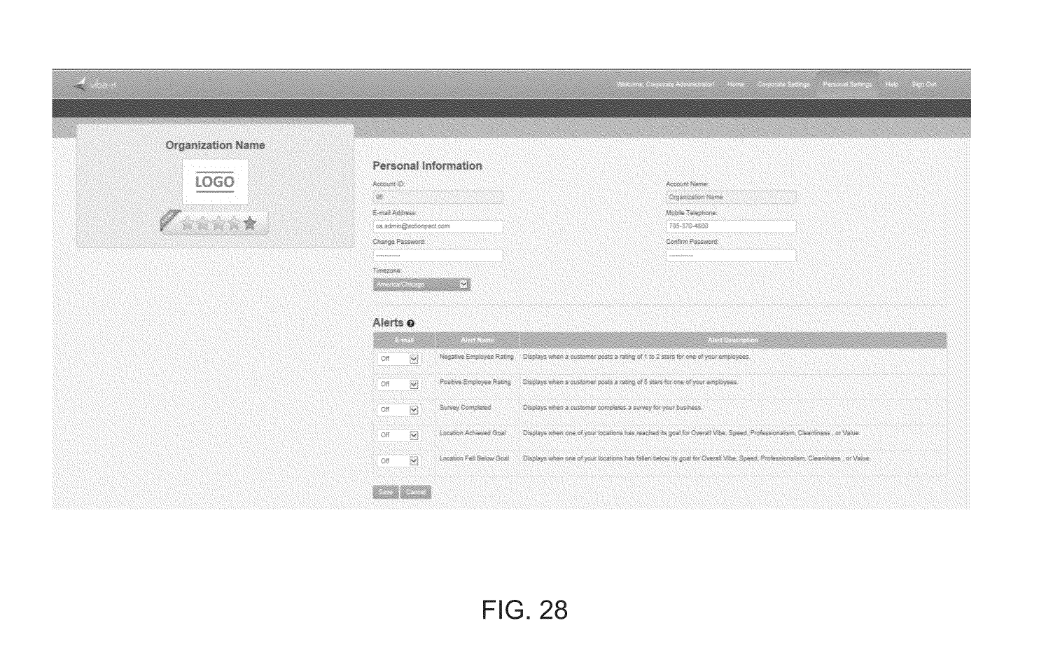

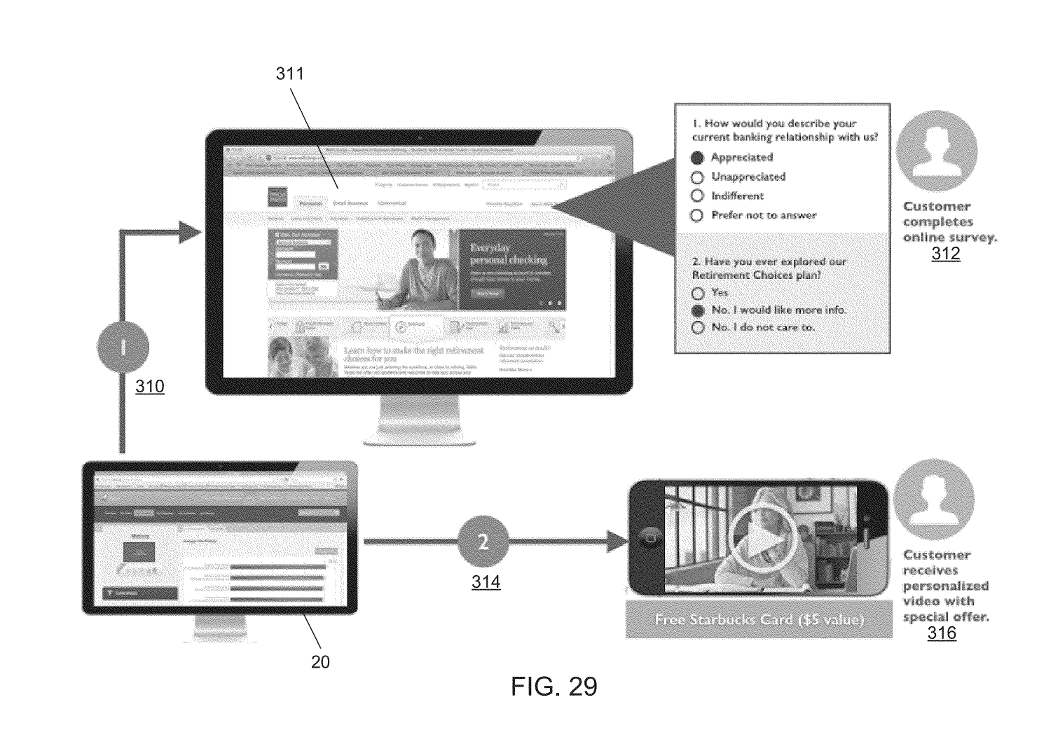

The CEC 20 also provides a personal settings tab as illustrated in FIG. 28. The personal settings tab allows a user to update personal settings within the CEC 20, such as an email address, a mailing address, a telephone number, a password, and alert settings (e.g., whether alerts are turned on for the user based on specific customer feedback or metrics). For example, in some embodiments, the alert settings allowing a user to specify when he or she should receive an alert from the CEC 20 based on collected customer feedback. For example, a threshold can be associated with particular metrics for an organization (e.g., an overall rating, a product rating, a location rating, etc.). If the metric fails to satisfy the threshold (e.g., drops below the threshold), the CEC 20 can be configured to automatically generate an alert for the user. The alert can include direct correspondence (e.g., an email message, text message, etc.) or can be presented to the user within the CEC 20.

As noted above, users can use the CEC 20 to create and publish surveys. FIG. 29 illustrates a method of providing a survey. For example, as illustrated in FIG. 29, a user creates a survey and publishes the survey to a website using the CEC 20 (e.g., using the user interfaces illustrated in FIGS. 2-28). The user also creates a video promotion associated with the survey using the CEC 20 (e.g., using the user interfaces illustrated in FIGS. 2-28). The user can also specify as part of the created survey that the promotion is provided if particular responses are received for the survey. For example, using the CEC 20, the user can specify that the promotion is displayed when a customer answers “No. I would like more info” to the second question included in the survey. Accordingly, as illustrated in FIG. 29, the user creates and publishes the survey (at step 310) (e.g., as link posted on the organization's website 311). A customer accesses the survey, completes the survey, and submits the survey (at block 312). The CEC 20 collects the response of the survey and, if appropriate, supplies the promotion to the customer (at block 314). The customer can access the promotion (e.g., watch video) and claim the offer included in the promotion (at block 316).

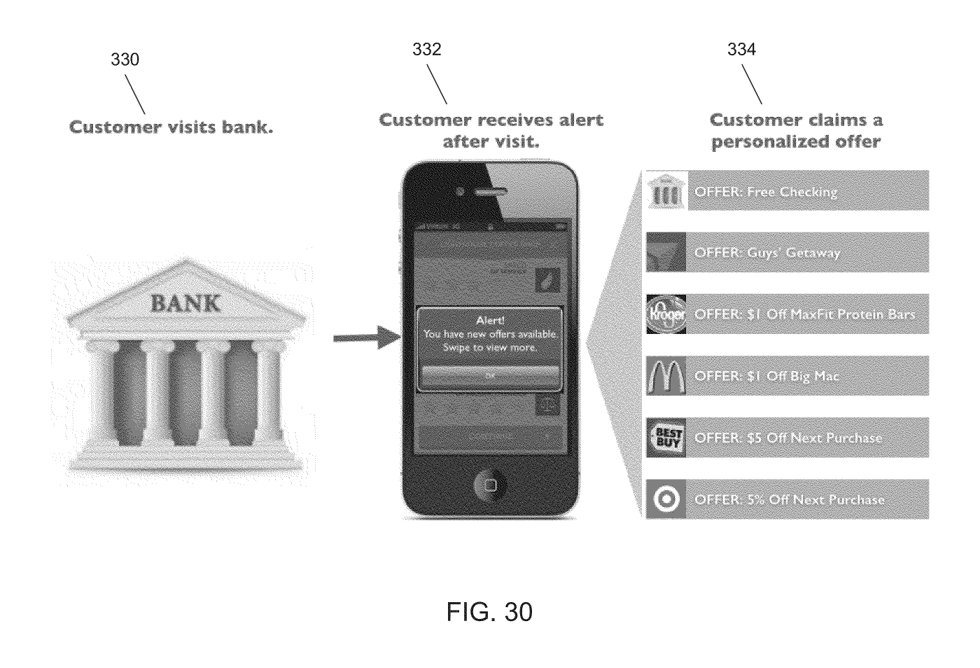

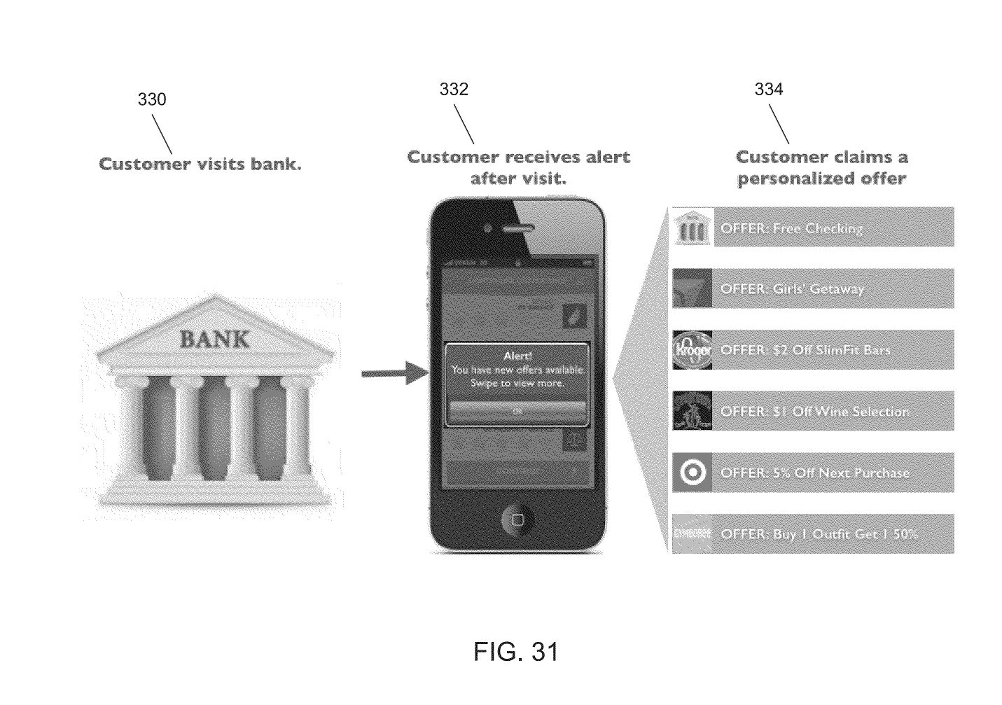

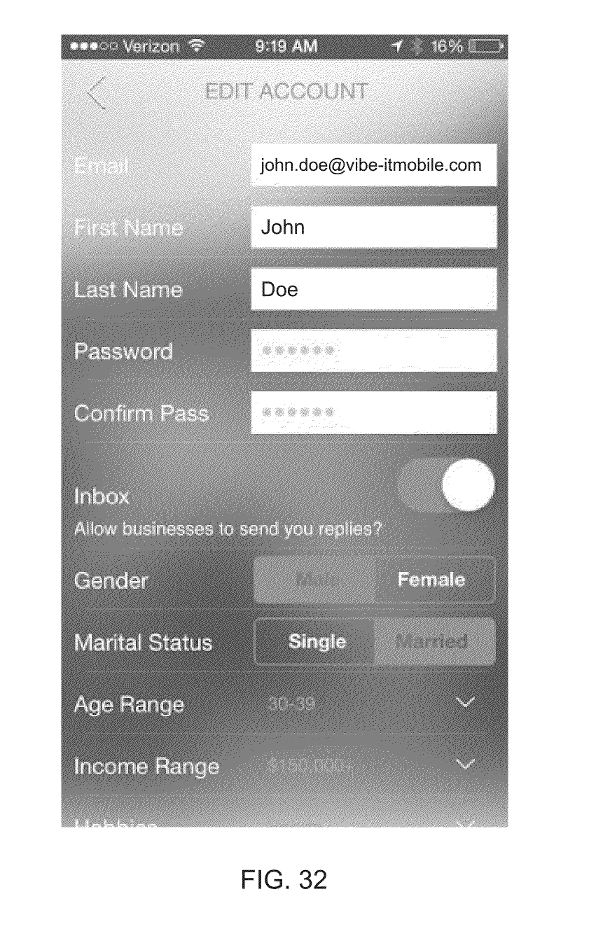

Similarly, FIGS. 31 and 32 illustrate methods for generating personalized promotions (e.g., offers). For example, in FIG. 31 a customer visits a bank (at block 330). The CEC 20 identifies the visit (e.g., using location tracking enabled on a mobile device carried by the customer) and access demographic information for the customer (e.g., from a customer database). The demographic information can include marital status, age (or age range), household size, and income (or income range). Based on the demographics, the CEC 20 generates and publishes a promotion directly to the customer (e.g., a mobile application installed on the customer's mobile phone or other mobile computing device) (at block 332). As illustrated in FIG. 30, the customer can receive an alert of the promotion and can claim the promotion (at block 334). In some embodiments, the promotion can include a list of available offers, and the customer can chose one or more of the available offers. Similarly, FIG. 31 illustrates a method of generating a similar promotion for a customer with different demographics.

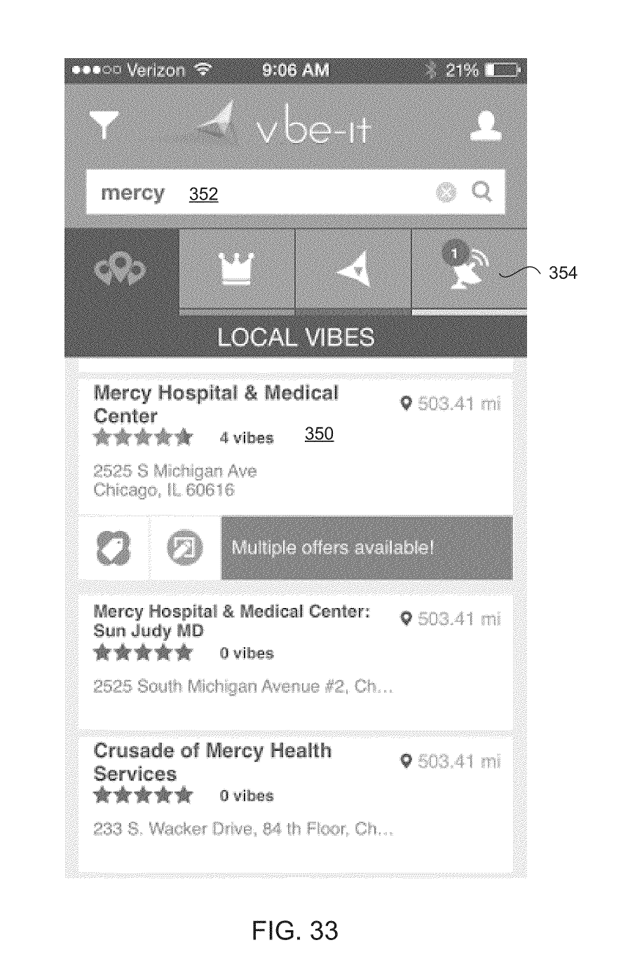

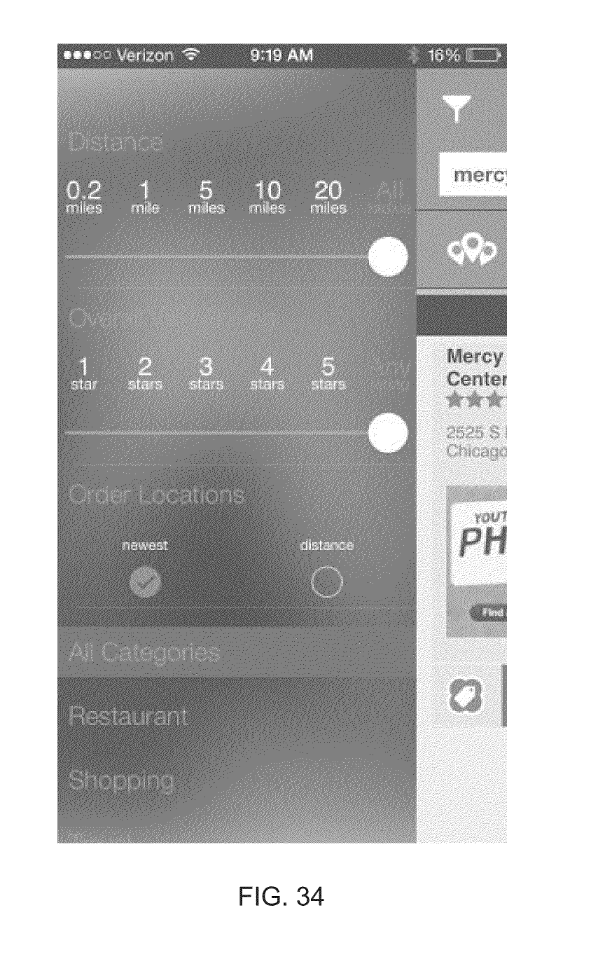

As noted above and as illustrated in FIGS. 30 and 31, the CEC 20 can communicate with a mobile application for receiving feedback and pushing campaigns. For example, a customer can provide feedback and receive campaigns (e.g., promotions) through a mobile application installed on a user device 30 (e.g., a smart phone). FIGS. 32-48 illustrate user interfaces provided through such a mobile application. For example, FIG. 32 illustrates an edit account screen that allows a customer to enter login information, demographics, and set permissions for feedback responses. FIG. 33 illustrates a local promotions tab. The local promotions tab can be an initial screen displayed by the mobile application after a customer logs in that shows organizations (or events provided by the organizations) 350 along with their ratings, active surveys, and promotions located near a geographical location of a customer. The local promotions tab can also include a search bar 352 that allows a customer to search for an organization (or event) by a keyword or a location (e.g., city). FIG. 34 illustrates a settings screen that allows a customer to provide settings for the organizations 350 displayed on the local promotions tab.

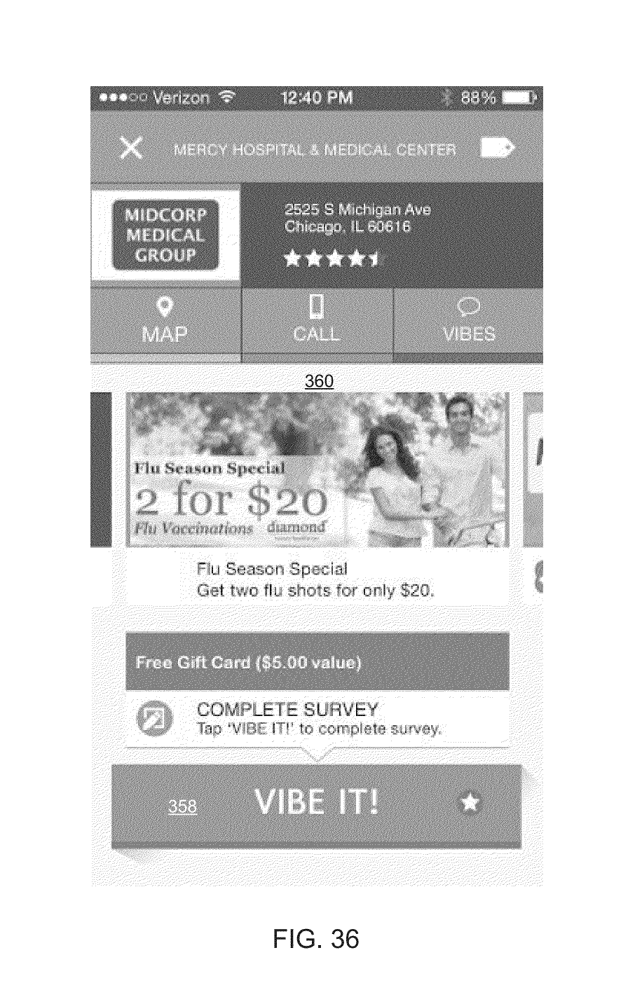

As illustrated in FIG. 33, the location promotions tab can include an alerts or notifications icon 354 that a customer can select to see new promotions (e.g., published specifically to the customer as an personalized promotion or a group promotion). For example, FIG. 36 illustrates a screen for viewing active promotions that have been published from the CEC 20. Promotions can be a static image, a link to a website, or a multi-media presentation (e.g., a video). If the promotion is a video, individuals can watch the video directly from the screen illustrated in FIG. 36. As noted above, the CEC 20 can be configured to track views of promotions so that organizations can track what promotions are getting the most views by customers. As noted above, in some embodiments, a promotion can include multiple offers. Accordingly, as illustrated in FIG. 36, a promotion can indicate whether the display promotion includes multiple offers.

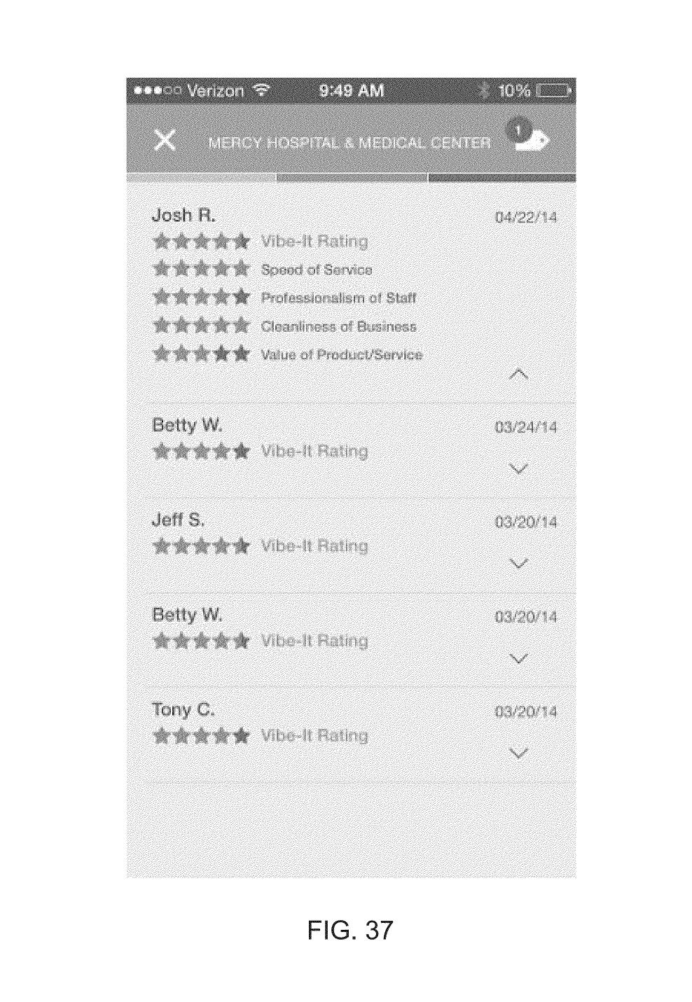

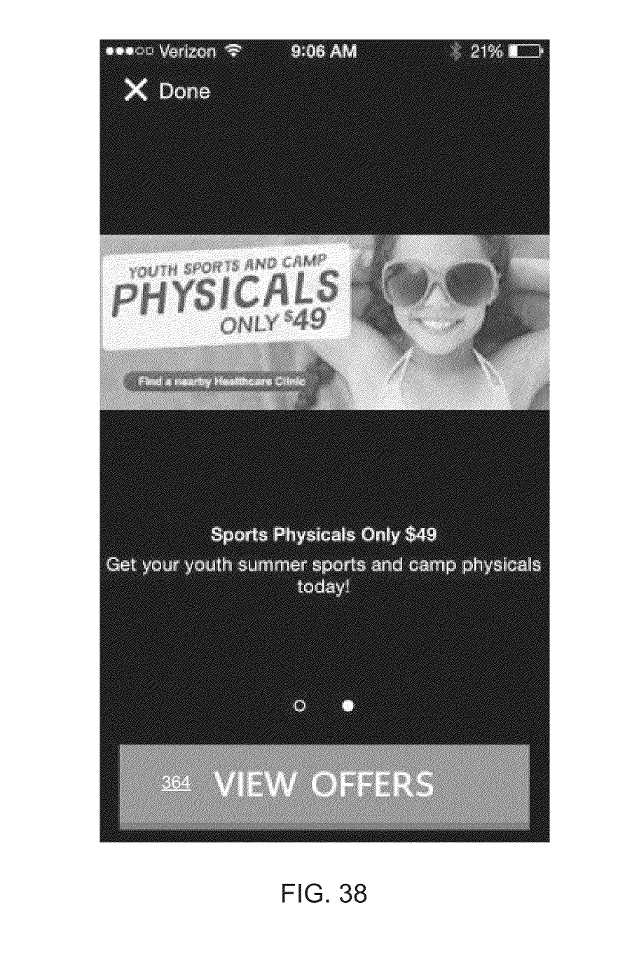

If a customer selects a promotion from the screen illustrated in FIG. 36, the application can display a screen, as illustrated in FIG. 36, that allows the customer to obtain information for all of the offers associated with the promotion (e.g., by scrolling horizontally) and view additional information about the organization associated with the promotion (e.g., location, map information, ratings, contact information, etc.). In some embodiments, a customer can select a rating displayed for an organization to view additional rating information (e.g., individual ratings or comments) as illustrated in FIG. 37. In some embodiments, a customer can also select a particular displayed offer to view more information about the offer, as illustrated in FIG. 38.

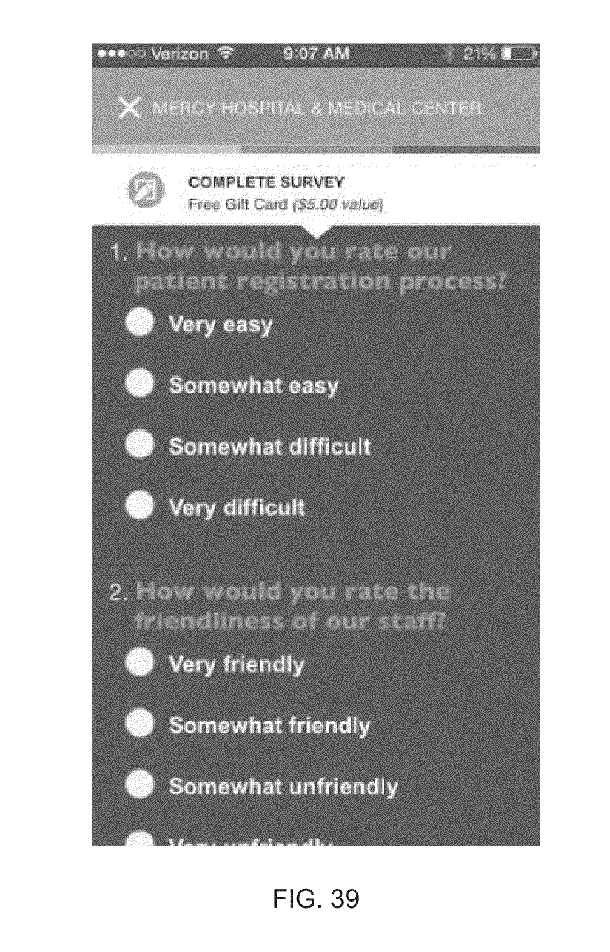

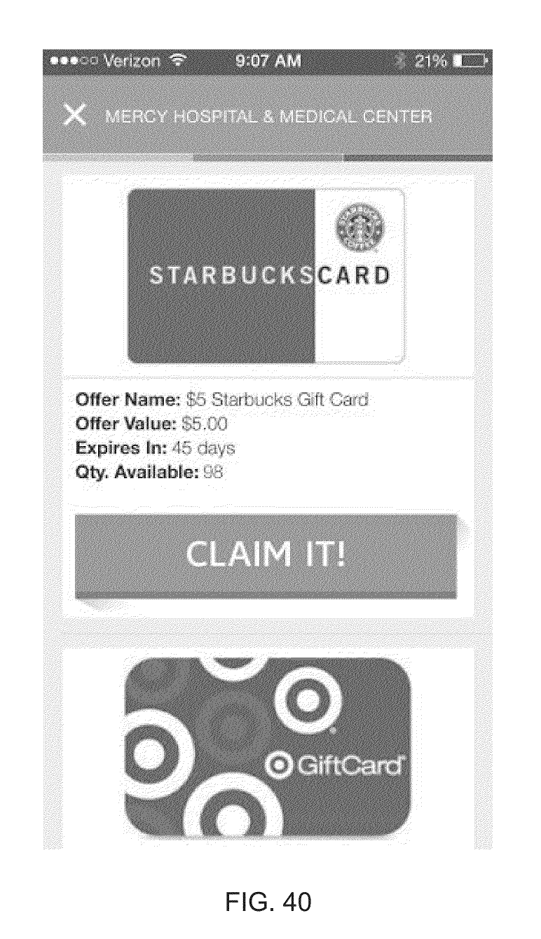

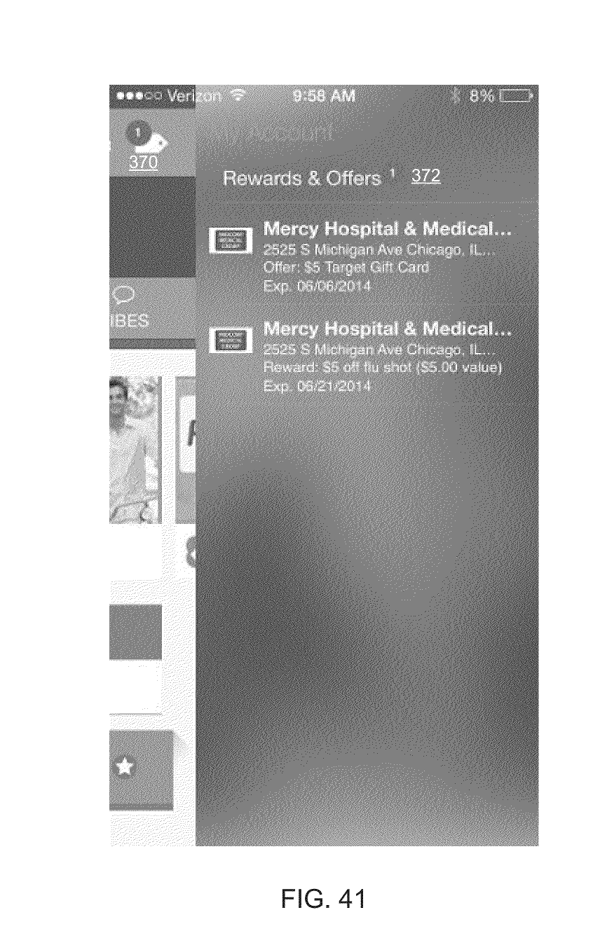

A customer can also claim an offer by selecting a mechanism 358 displayed for a particular offer. Selecting the mechanism 358 can take the customer to the survey or other campaign associated with the offer (see, e.g., FIG. 39). Upon completing the survey or any other requirements for the offer (if any), the customer can view the available offers associated with completing the requirements, as illustrated in FIG. 40, and claim one or more offers. As illustrated in FIG. 41, the mobile application can be configured to track claimed offers, including the offers expiration dates. In some embodiments, the mobile application can also provide indicators (e.g., flags, etc.) that alert the customer of available claimed offers. Again, the CEC 20 can track offers claimed by customers so that organizations can track what offers are being claimed most frequently.

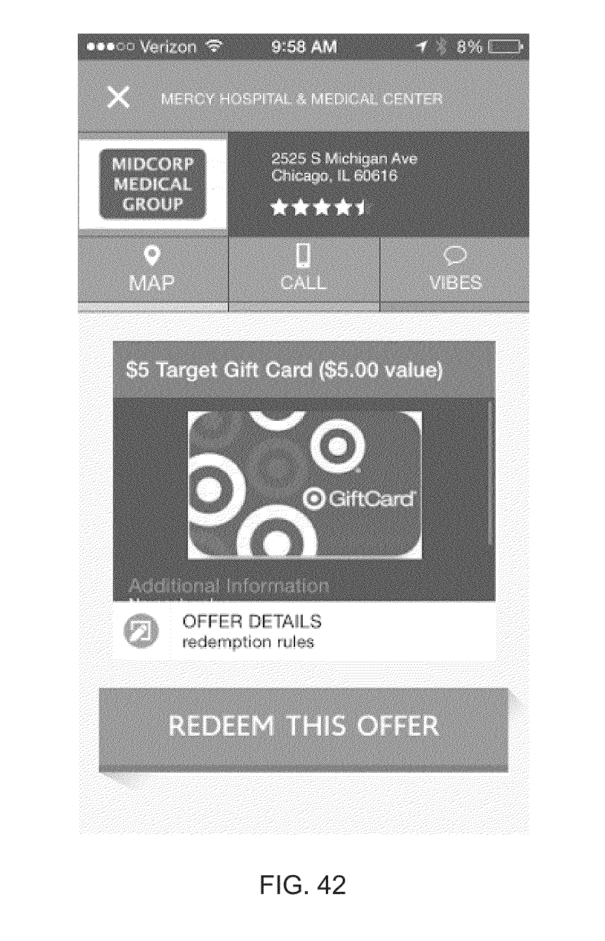

Claimed offers can be redeemed electronically (e.g., online) or at specific organization locations. For example, FIG. 42 illustrates a redeem offer screen that allows a customer to select a claimed offer and redeem a selected claimed offer, which may provide a bar code or other code for use in a transaction. Once redeemed, a claimed offer may no longer be available through the mobile application. In some embodiments, an indicator (e.g., an animation or flashing bar) can be displayed with a redeemed offer to indicate that the offer is live, which can help prevent customers from taking a snapshot of an offer and redeeming it multiple times at one or multiple locations.

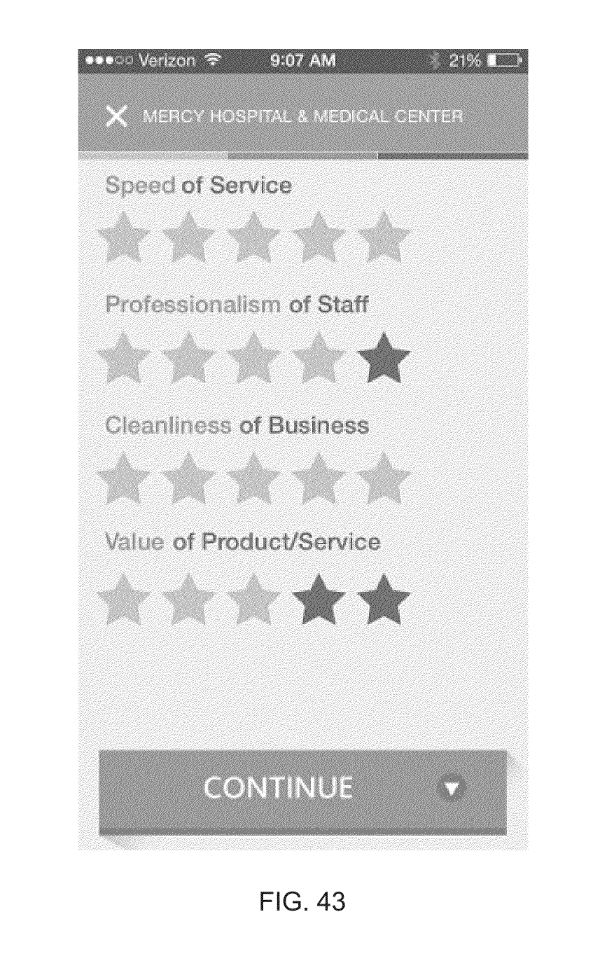

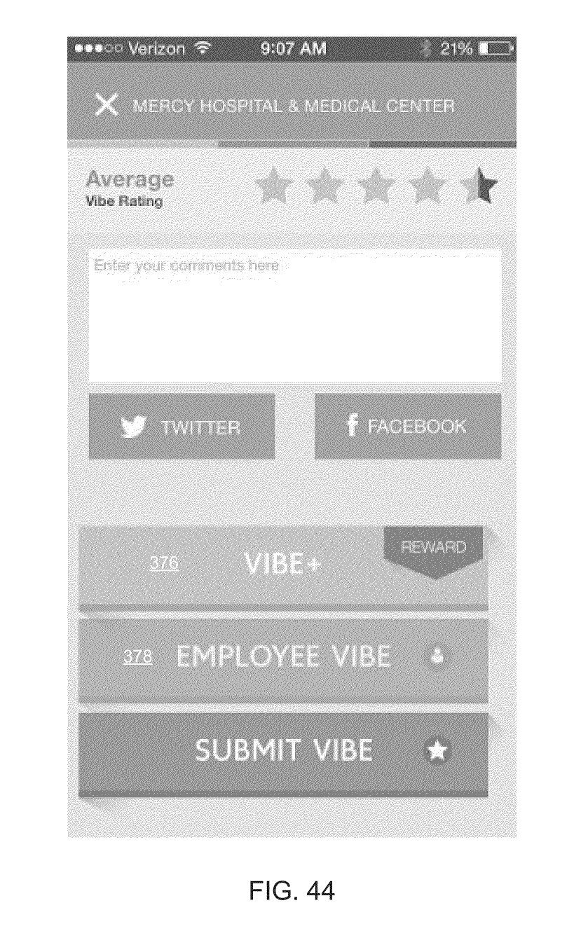

A customer can also use the mobile application to provide feedback independent of a campaign. For example, as illustrated in FIG. 43, a customer can rate their experience with a particular organization based on a rating system (e.g., 1 to 5 stars). The metrics can include speed of service, professionalism of staff, cleanliness of business, and value of product/service. As illustrated in FIG. 44, a customer can also provide comments for an organization. In some embodiments, a customer can use the mobile application to publish ratings and/or comments to other channels 40, such as a social media website.

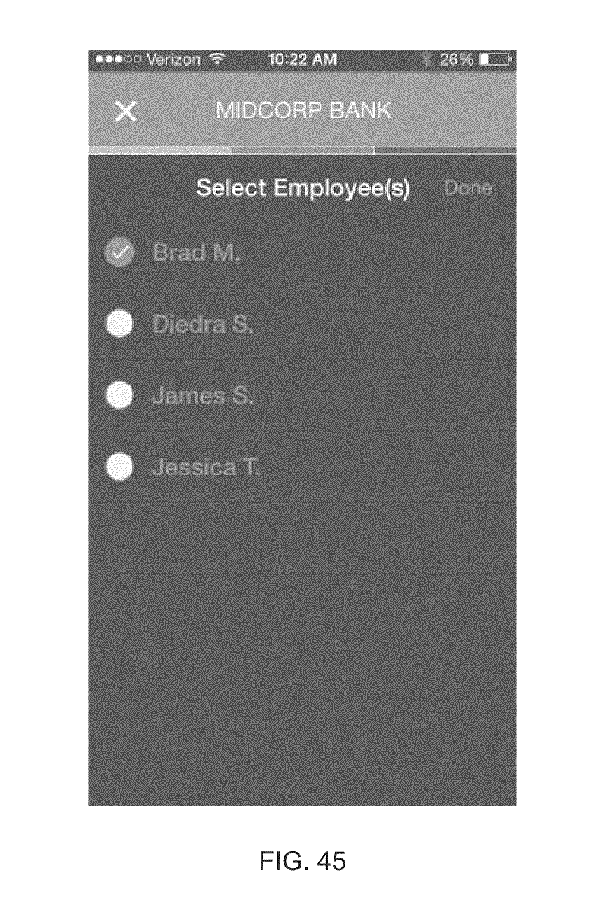

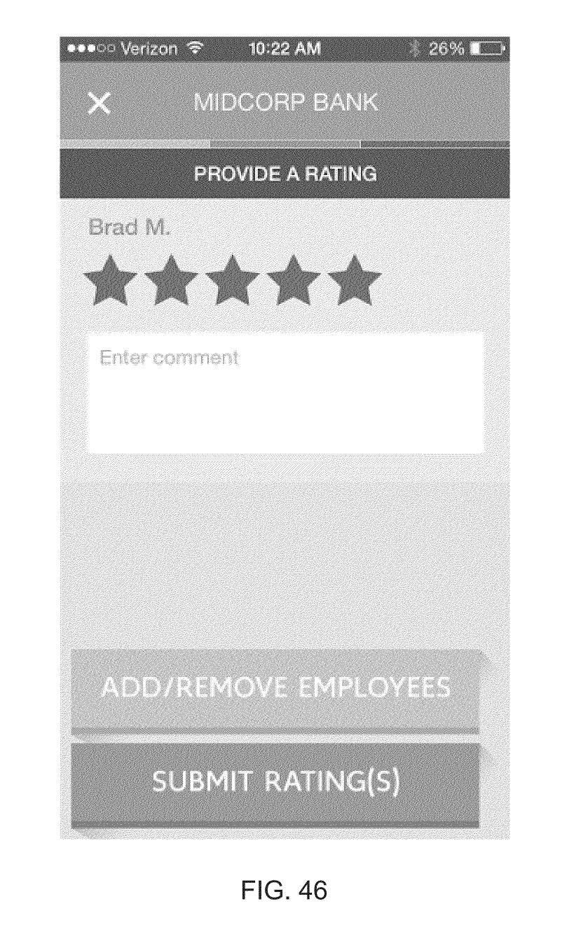

In some embodiments, a customer can also provide feedback on specific employees, contractors, or other individuals (collectively referred to as “employees” herein) associated with an organization. For example, FIG. 45 illustrates an employee rating screen where a customer can select one or multiple employees to rate. As illustrated in FIG. 46, a customer can provide a rating for an employee and comments for an employee.

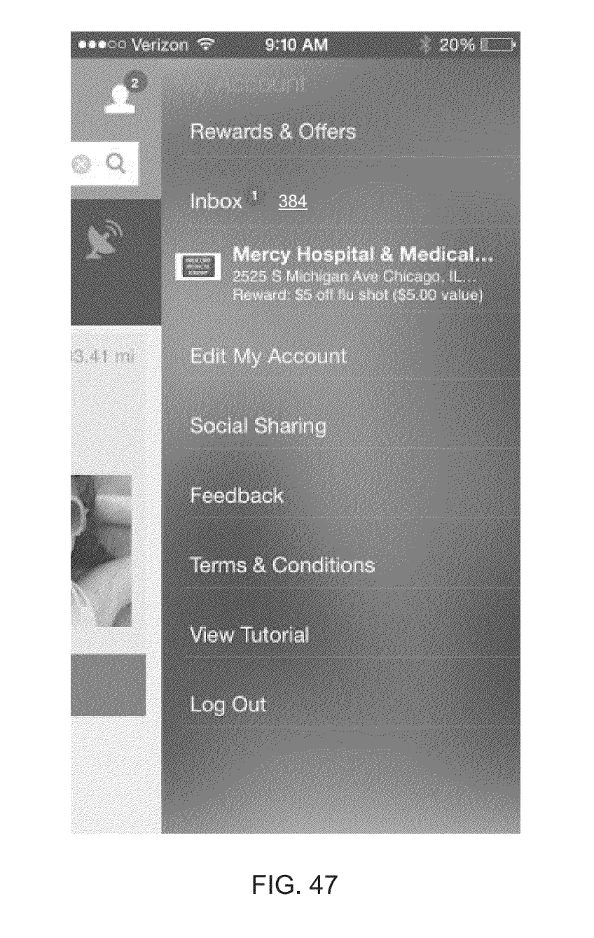

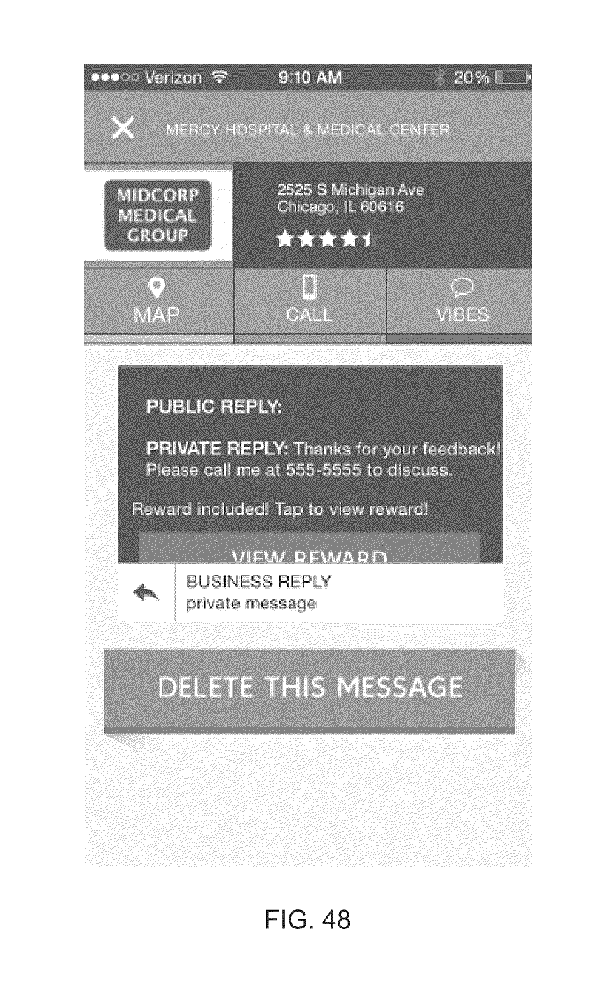

As noted above, when a customer provides feedback for an organization, the CEC 20 collects the feedback and can notify or alert the organization accordingly (e.g., via email messages or notifications provided within the CEC 20). An organization can also respond to feedback through the CEC 20. As described above, the organization can respond to feedback publicly and/or privately (e.g., separate responses for the customer providing the feedback and all customers). For example, a customer can access public response on various channels 40, including the organization's website or through a mobile application. Similarly, a customer can access private responses in direct correspondence (e.g., mailing, email message, phone call, text message, etc.) or through a mobile application (e.g., as an in-application private message). For example, FIGS. 47 and 48 illustrate private responses received by the mobile application. As illustrated in FIG. 48, in some embodiments, a private response can also include any associated public response. Also, in some embodiments, as illustrated in FIG. 48, an organization can include a reward or other offer with a private or public response.

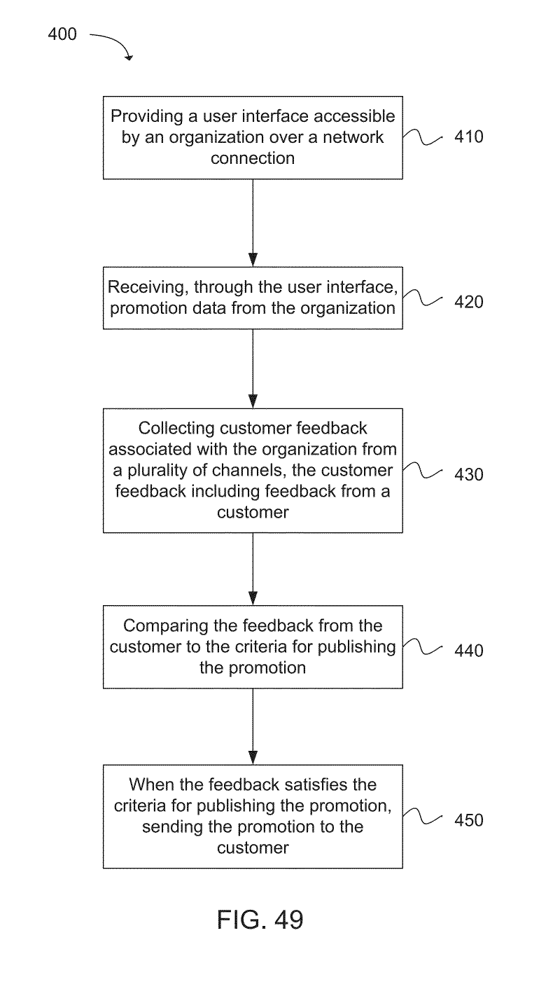

The flow chart shown in FIG. 49 illustrates a method 400 performed by the CEC 20 (e.g., the server 12 executing the CEC 20) for sending a promotion to a customer. The method 400 includes providing a user interface accessible by an organization over a network connection (block 410). The method also includes receiving, through the user interface, promotion data from the organization, the promotion data including at least one offer, an end or expiration date, and criteria for publishing the promotion follows (at block 420). For example, FIG. 16 described above illustrates a user interface for managing promotions. As noted above, the criteria for a promotion can include a type of feedback (e.g., survey answers or trivia answers), a type of indirect customer feedback (e.g., usage information), a customer demographic (e.g., gender, marital status, household size, salary, geographic location, etc.), a customer preference, a geographic location associated with the organization visited by the customer, an event associated with the organization attended by the customer, and the channel on which the feedback was collected.

As illustrated in FIG. 49, the method 400 also includes collecting customer feedback associated with the organization from a plurality of channels, wherein the customer feedback includes customer feedback from the customer (at block 430), comparing the customer feedback from the customer to the criteria for publishing the promotion (at block 440), and sending the promotion to the customer when the customer feedback satisfies the criteria for publishing the promotion (at block 450).

Thus, embodiments of the invention provide a system for collecting customer feedback received through multiple channels at a central location where organizations can view and respond to the feedback as necessary. The system also allows organizations to create and publish campaigns, including promotions that are published to one or more channels. When creating a campaign, an organization can specify criteria for the campaign, such as the type of feedback to publish the campaign in response to. Therefore, campaigns received by a customer can be tailored based on the customer's previous feedback (e.g., direct or indirect). The system also provides a mobile application that allows customers to provide feedback, receive feedback responses, and view organization campaigns. All of these features help an organization manage large amounts of customer feedback collected through multiple electronic channels, while personalizing customer interactions.

Various features and advantages of the invention are set forth in the following claims.

What is claimed is:

1. A computer-implemented method for sending a promotion to a customer, the method including:
providing, with a server, a user interface accessible by an organization over a network connection;
receiving through the user interface, with the server, promotion data from the organization for the promotion, the promotion data including at least one offer, an expiration date, and criteria for publishing the promotion;
collecting, with the server, customer feedback associated with the organization from a plurality of channels, the customer feedback including feedback from the customer;
comparing, with the server, the feedback from the customer to the criteria for publishing the promotion; and
when the feedback satisfies the criteria for sending, with the server, the promotion to the customer.

2. The method of claim 1, wherein collecting the customer feedback from the plurality of channels includes collecting the customer feedback from at least one selected from a group consisting of a website associated with the organization, a social media website associated with the organization, a mobile application associated with the organization.

3. The method of claim 1, wherein collecting the customer feedback includes collecting direct customer feedback including at least one selected from a group consisting of an email, a complaint, a compliment, a comment, a survey response, a trivia answer, a social media message, and a customer rating.

4. The method of claim 1, the method further comprising:
providing the feedback from the customer to the organization through the user interface;
providing a response form with a private response field and a public response field to the organization through the user interface;
receiving, through the response form, a first response from the organization for the private response field and a second response from the organization for the public response field, the first response and the second response being in response to the feedback;
sending the first response only to the customer; and
sending the second response to a plurality of customers including the customer over at least one of the plurality of channels.

5. The method of claim 1, wherein collecting the customer feedback includes collecting indirect customer feedback including at least one selected from a group consisting of traffic and usage information, campaign viewings, promotion redemptions, rewards collected, and reward points accumulated.

6. The method of claim 1, wherein receiving the promotion data including the criteria includes receiving at least one selected from a group consisting of a type of direct customer feedback, a type of indirect customer feedback, a customer demographic, a customer preference, a geographic location associated with the organization visited by the customer, an event associated with the organization attended by the customer, and a channel included in the plurality of channels.

7. The method of claim 1, wherein sending the promotion to the customer includes sending the promotion to the customer through at least one of the plurality of channels.

8. The method of claim 1, wherein receiving the promotion data including the at least one offer includes receiving at least one selected from a group consisting of an advertisement, a video, a link to a website, a coupon, a reward, reward points, and a contest entry.

9. The method of claim 0, the method further comprising:
receiving through the user interface a customer feedback mechanism from the organization, the customer feedback mechanism including at least one selected from a group consisting of a survey and a rating; and
publishing the customer feedback mechanism to at least one of the plurality of channels.

10. The method of claim 0, the method further comprising:
generating a report based on the customer feedback; and
making the report accessible to the organization through the user interface.

11. The method of claim 10, wherein generating the report includes generating at least one selected from a group consisting of a rating of a service, a rating of an employee, a rating of a product, a rating of the organization, a rating of the promotion, and a rating of an event.

12. The method of claim 10, the method further comprising comparing at least one metric included in the report to a threshold and automatically generating an alert for at least one user associated with the organization when the at least one metric does not satisfy the threshold.

13. A system for sending a promotion to a customer, the system comprising:
a server configured to:
provide a user interface accessible by an organization over a network connection;
receive, through the user interface, promotion data from the organization for the promotion, the promotion data including at least one offer, an expiration date, and criteria for publishing the promotion;
collect customer feedback associated with the organization from a plurality of channels, the customer feedback including feedback from the customer;
compare the feedback from the customer to the criteria for publishing the promotion; and
send the promotion to the customer when the feedback satisfies the criteria for publishing the promotion.

14. The system of claim 13, wherein the plurality of channels includes at least one selected from a group consisting of a website associated with the organization, a social media website associated with the organization, a mobile application associated with the organization.

15. The system of claim 13, wherein the customer feedback includes direct customer feedback including at least one selected from a group consisting of an email, a complaint, a compliment, a comment, a survey response, a trivia answer, a social media message, and a customer rating.

16. The system of claim 13, wherein the server is further configured to:
provide the feedback from the customer to the organization through the user interface;
provide a response form with a private response field and a public response field to the organization through the user interface;
receive, through the response form, a first response from the organization for the private response field and a second response from the organization for the public response field, the first response and the second response being in response to the feedback;
send the first response only to the customer; and
send the second response to a plurality of customers including the customer over at least one of the plurality of channels.

17. The system of claim 13, wherein the customer feedback includes indirect customer feedback including at least one selected from a group consisting of traffic and usage information, campaign viewings, promotion redemptions, rewards collected, and reward points accumulated.

18. The system of claim 13, wherein the criteria includes at least one selected from a group consisting of a type of direct customer feedback, a type of indirect customer feedback, a customer demographic, a customer preference, a geographic location associated with the organization visited by the customer, an event associated with the organization attended by the customer, and a channel included in the plurality of channels.

19. The system of claim 13, wherein the server is configured to send the promotion to the customer through at least one of the plurality of channels.

20. The system of claim 13, further comprising a mobile application configured to communicate with the server and wherein the server is configured to send the promotion to the customer by sending the promotion to the mobile application.
